(19) United States
(12) Patent Application Publication
(10) Pub. No.: US 2014/0342043 A1
(43) Pub. Date: Nov. 20, 2014

(54) Rebaudioside Sweetener Compositions and Food Products Sweetened with Same

(71) Applicant: PepsiCo, Inc., Purchase, NY (US)

(72) Inventors: Zena Bell, Hartsdale, NY (US); Thomas Lee, Scarsdale, NY (US); Gregory Yep, New Canaan, CT (US)

(73) Assignee: PepsiCo, Inc., Purchase, NY (US)

(21) Appl. No.: 13/894,200

(22) Filed: May 14, 2013

(51) Int. Cl. A23L 2/60

(52) U.S. Cl. CPC A23L 2/60
USPC 426/72; 426/658; 426/590; 426/548

(57) ABSTRACT

Sweetener compositions suitable for use in beverage products and other food products are disclosed, as well as food products sweetened with the novel sweetener compositions. Disclosed food products include dry foods and beverage products, such as carbonated or un-carbonated ready-to-drink beverages as well as syrups for dilution to make ready-to-drink beverages, such as diet or other reduced calorie beverages. The sweetener composition comprises at least a sweetening amount of rebaudioside M together with at least one other one other edible ingredient or food ingredient. The disclosed food products comprise rebaudioside M sweetener with at least one other one other edible ingredient or food ingredient.

### FIELD OF THE INVENTION

This invention relates to novel sweetener compositions food products, including beverage products, sweetened at least partly with the novel sweetener compositions. In particular, a previously unused, potent rebaudioside sweetener and products sweetened with it are disclosed, for example, cola and other carbonated soft drinks, hydration beverages having added electrolytes and other un-carbonated beverage products, grain products such as sweetened dry cereals, and other foods.

### BACKGROUND

There is a need for new food and beverage formulations which can adequately meet one or a combination of objectives including nutritional characteristics, flavor, shelf life, and/or other objectives. Improved and new formulations for beverages and other foods are desirable to meet changing market demands. In particular, there is market demand for sweetened beverages and other sweetened foods having lower calorie content. Also, there is market demand for diet and low calorie sweetened beverages and foods having improved flavor profiles, including, e.g., good taste, good sweetness profile, etc.

The development of new food and beverage formulations employing alternative sweeteners, flavorants, flavor enhancing agents and the like, presents challenges in addressing associated bitterness and/or other off-tastes. Thus, for example, development of new, diet (i.e., zero or fewer than 5 calories per 8 oz. serving) or reduced calorie formulations for sweetened beverages, e.g., carbonated cola beverages with good flavor and sweetness profile, has faced obstacles. For example, U.S. Pat. No. 4,956,191 suggests that carbonated beverages which contain blends of saccharin or stevia extract with aspartame tend to be less organoleptically pleasing than those containing sugar. Similarly, rebaudiosides and other steviol glycosides known for use as sweeteners, in addition to providing sweetness, have in many food formulations been found to exhibit unacceptably low up front sweetness, lingering bitterness, or other off-tastes.

Steviol glycosides include potent, non-nutritive sweeteners, sweet-tasting compounds that can be extracted as a natural sweetener from the stevia plant (Stevia rebaudiana Berton). Typically, these extracts are reported to include primarily stevioside (e.g., at 4-13% dry weight of the stevia plant leaves) and rebaudioside A (e.g., at 2-4% dry weight of the stevia plant leaves). High purity steviol glycoside sweeteners, e.g., rebaudioside A (also referred to here in some cases as “Reb A”) sweeteners are produced and sold commercially.

It is an object of the present invention to provide new sweetener compositions having desirable taste and nutritional characteristics. It is another object to provide sweetened food products, e.g., beverage products and dry food products, having good sweetness profiles. It is an object of at least certain embodiments of the invention (that is, not necessarily all embodiments of the invention) to provide diet and low calorie carbonated soft drinks, e.g. diet cola beverages, and syrups for making such beverages, having desirable taste properties and lower caloric content. It is an object of at least certain embodiments of the invention to provide sweetened, organic and/or all-natural beverages and other sweetened food products. These and other objects, features and advantages of the invention or of certain embodiments of the invention will be apparent to those skilled in the art from the following disclosure and description of exemplary embodiments.

### SUMMARY

The present invention relates to new sweetener compositions, to new beverage products and other new food products as further disclosed and described below, which comprise a sweetening amount of rebaudioside M, that is, have rebaudioside M present in a concentration sufficient to perceptibly sweeten the food product. Rebaudioside M is a potent sweetener that can be produced by extraction from Stevia rebaudiana plant leaves, optionally followed by purification to obtain either pure rebaudioside M or to increase the concentration of rebaudioside M relative to other components of the extract, such as Reb A. It also can be produced enzymatically or synthetically. Some aspects of the present invention relate to beverage products sweetened with rebaudioside M, including beverage syrups (i.e., concentrates to be diluted with carbonated or un-carbonated (i.e., still) water to form ready-to-drink beverages, organic and/or natural beverages (i.e., beverage products made essentially of only organic and/or only natural ingredients), and other beverage products. Rebaudioside M has been found to have a sweetness intensity significantly higher than Reb A, and has also been found to provide beverages and other food products with a more desirable sweet taste profile than the same foods sweetened with other potent sweeteners, such as the other steviol glycosides, e.g., sweetened only with Reb A, or sweetened with artificial potent sweeteners, e.g., in cola beverage products, including more up front sweetness and substantially less bitter aftertaste.

According to a first aspect, a food product comprises a sweetening amount of rebaudioside M and at least one other food ingredient. As used here, the term “food ingredient” means any edible substance suitable to provide flavor, nutrition, color, bulk, texture or other mouthfeel, stability, acidity, thickening, anti-caking or the like, or a combination of any two or more of these. As further discussed below, exemplary food ingredients suitable for use in the novel food products disclose here include grain components, carbonated or non-carbonated water, other sweeteners, e.g., a sweetening amount of at least one nutritional sweetener, flavorants, acidulants, colorants, bulking agents, etc. In certain exemplary (i.e., non-limiting) embodiments, the food products disclose here comprising rebaudioside M are packaged in a single serving quantity. The food products of this aspect of the disclosure include, for example, solid foods, gels, beverages, etc. The beverages include, for example, juice beverages (e.g., beverages comprising one or more fruit juices and/or one or more vegetable juices), hydration beverages, carbonated soft drinks (CSDs), frozen beverages, frozen carbonated beverages, diet or other reduced calorie beverages, etc. It will be recognized by those skilled in the art that there is overlap between these categories. As used herein, “reduced calorie beverage” means a beverage having at least a 25% reduction in calories per 8 oz. serving of beverage as compared to the full calorie version, typically a previously commercialized full-calorie version (e.g., wherein substantially all of the sweetening comes from a nutritive sweetener, such as sucrose, HFCS or the like). In at least certain embodiments, a reduced calorie beverage has about a 50% reduction in calories per 8 oz. serving as compared to the full calorie version. As used herein, a “low-calorie beverage” has fewer than 40 calories per 8 oz. serving of beverage. As used herein, “zero-calorie” or “diet” means having less than 5 calories per serving, e.g., per 8 oz. for beverages.

According to another aspect, beverage products are provided that comprises water, and acidulant component comprising at least one acid, a flavoring component comprising at least one flavoring ingredient, and a sweetener component comprising a sweetening amount of rebaudioside M and optionally a sweetening amount of one or more other sweeteners. In certain exemplary embodiments of the beverage products according to this aspect, the beverage products are ready-to-drink beverages having a pH higher than 3.0 and lower than 4.0. Such ready-to-drink beverages may, for example, be hydration beverages, also referred to as sports drinks, having added electrolytes. In other exemplary embodiments the ready-to-drink beverages are carbonated soft drinks, for example reduced calorie or diet cola beverages. In certain exemplary embodiments of the beverage products according to this aspect, the beverage products are syrups suitable to be diluted, for example, by a 1-plus-5 throw with carbonated or un-carbonated water to produce a ready-to-drink beverage. The rebaudioside M may be natural or synthetic and may have any suitable purity (referring here to the purity of the rebaudioside M “as used,” that is, in the form it is in when added to one or more other ingredients of the beverage product). For example, the rebaudioside M may have a purity of at least 85%, or a higher purity such as 90% or 95%, where all such percentages are the weight percent of the rebaudioside M in the purified stevia extract or the weight percent of the rebaudioside M in the synthetically produced rebaudioside M sweetener ingredient, that is, the weight percent of the actual rebaudioside M compound (in whatever hydrated or anhydrous form it occurs in the sweetener ingredient).

In certain embodiments of the beverage products according to this aspect, the sweetener component consists essentially of rebaudioside M. That is, no other ingredient of the beverage product perceptibly increases the sweetness of the product. Other products may be included that are known to have a sweetening effect when used in sufficient concentration in other formulations, if they do not have a sweetening effect in the beverage product of the subject exemplary, including, for example, ingredients added for other purposes (e.g. bulking) and ingredients included only as a trace or insignificant ingredient in some other ingredient of the beverage product. In those alternative embodiments in which the sweetener component further comprises at least one other sweetener, such other sweetener may be natural or artificial and may be a sweetening amount of potent sweetener (e.g., Reb A, aspartame, etc.) or of a non-potent sweetener (e.g., sucrose, etc.). In the beverage products according to this aspect of the disclosure, the rebaudioside M typically is used in an amount, i.e., a concentration greater than 10 ppm, e.g., 100 ppm to 600 ppm. For example, in a ready-to-drink diet cola beverage the concentration of rebaudioside M may be from 10 ppm to its limit of solubility, e.g., at a concentration of greater than 50 ppm, or at a concentration greater than 300 ppm. As noted above, the beverage product may be a syrup suitable to be diluted, e.g., by a 1-plus-5 throw with carbonated water to produce a ready-to-drink, diet, carbonated cola beverage having a pH higher than 3.0 and lower than 4.0, and the concentration of the rebaudioside M in finished beverage is one sixth (⅙) its concentration in the syrup.

Certain exemplary embodiments of the beverage products according to this aspect, e.g., a ready-to-drink, diet, carbonated cola beverage or the syrup for producing such beverage, may further comprise erythritol, D-tagatose, D-psicose, or a combination of any two or all three of them in concentrations sufficient collectively in the rebaudioside M-sweetened formulation of the particular beverage product embodiment to provide improved mouthfeel and improved up-front sweetness. In certain such embodiments erythritol and D-psicose each is used in an amount that is (independently of each other) from 0.5 wt. % to 1.5 wt. % of a rebaudioside-sweetened ready-to-drink beverage or of a rebaudioside-sweetened ready-to-eat food, e.g., about 1 wt. % each. For example, carbonated diet cola beverages can be prepared with formulations mimicking traditional full-calorie carbonated ready-to-drink cola except that (i) the sweetener component consists essentially of rebaudioside M instead of sugar or HFCS, and (ii) 1.0 wt. % each of erythritol and D-psicose are included in the rebaudioside M-sweetened beverage. Such rebaudioside M-sweetened formulations can have good upfront sweetness, good middle sweetness, good end sweetness and good mouthfeel, without unacceptable licorice or lingering bitter taste. The rebaudioside M-sweetened formulations can, therefore, be substantially comparable to the traditional, full calorie, sugar-sweetened carbonated cola beverage.

According to another aspect, sweetener compositions are provided which comprise a sweetening amount of rebaudioside M and at least one other edible ingredient. In certain embodiments the sweetener composition is a table top sweetener suitable to be used in cooking or to be added by a consumer to a beverage or other food. Such sweetener composition can be packaged and sold in bulk. Alternatively, in certain embodiments the sweetener composition is packaged in single serving packets to be opened at the time of use by the consumer. The at least one other edible ingredient of the sweetener composition, in accordance with certain embodiments, may, for example, be a flavorant, e.g., flavorant below, at or barely above its threshold perception level or in an amount readily perceptible to the consumer, a flowing agent, a coloring agent, a bulking agent to provide ease of handling and/or improved mouthfeel in beverages and other food products in which the rebaudioside M sweetener composition is used, and/or other suitable ingredient, or a combination of any two or more of them. In certain embodiments the bulking agent(s) can provide an improved sweetness profile by increasing the up-front sweetness provided by the rebaudioside M sweetener composition. In certain embodiments the at least one other edible ingredient is erythritol, D-tagatose, and/or D-psicose, for example a combination of two or more of those ingredients is included in the sweetener composition, such as erythritol and D-tagatose, or erythritol and D-psicose, or D-tagatose and D-psicose.

According to another particular aspect, reduced calorie (e.g., diet) carbonated cola beverage products are provided comprising acidulant comprising at least one acid, a sweetener component comprising a sweetening amount of rebaudioside M, and a flavoring component comprising cola flavoring. In certain embodiments of the beverage products according to this aspect, rebaudioside M is the only sweetener ingredient present in a sweetening amount in the cola beverage, and in other embodiments one or more non-potent sweeteners are included in the cola beverage but rebaudioside M is the only potent sweetener ingredient present in a sweetening amount, i.e., in an amount that would add perceptible sweetness to the cola beverage (ignoring any pseudo-sweetening effect of an ingredient that is not itself a sweetener, such as a sweetness enhancer). In other embodiments the carbonated cola beverage product further comprises an additional sweetener, e.g., at least one sweetener selected from the group consisting of other Steviol glycosides, or more particularly other rebaudiosides, e.g., rebaudioside A, rebaudioside D, sucrose, HFCS, monatin, thaumatin, monellin, brazzein, L-alanine, glycine, Lo Han Guo, hernandulcin, phyllodulcin, trilobtain, and combinations of any two or more of them. Optionally, every sweetening ingredient in the cola beverage product is a potent sweetener (alternatively referred to as a high intensity sweetener), for example, a natural high intensity sweetener.

In certain embodiments one or more non-potent sweeteners are included in a beverage or other food product comprising rebaudioside M in accordance with this disclosure, for example, sucrose, high fructose corn syrup, erythritol, D-tagatose, D-psicose and/or others, or a combination of any two or more of them. According to certain embodiments, rebaudioside M provides at least 10% of the total sweetening of a cola beverage product, e.g. a diet cola syrup, a ready-to-drink diet cola beverage, another beverage product, or another food product in accordance with the present disclosure. According to certain embodiments, rebaudioside M provides at least 20% of the total sweetening, or at least 30% of the total sweetening, or at least 40% of the total sweetening, or at least half of the total sweetening, or at least 60% of the total sweetening, or at least 70% of the total sweetening, or at least 80% of the total sweetening, or at least 90% of the total sweetening. According to certain embodiments, rebaudioside M is at least 10 weight percent (sometimes abbreviated here as “wt. %” or “wt. percent” etc.) of the total weight of potent sweeteners in the cola beverage product. According to certain other embodiments, rebaudioside M is at least 20 wt. % of all potent sweeteners in the cola beverage product, or at least 30 wt. %, or at least 40 wt. %, or at least half of the total weight of potent sweeteners, or at least 60 wt. %, or at least 70 wt. %, or at least 80 wt. %, or at least 90 wt. %. According to certain other embodiments, rebaudioside M is at least 10 wt. % of all sweetener ingredients in the cola beverage product, or at least 20 wt. %, or at least 30 wt. %, or at least 40 wt. %, or at least half of the total weight of sweeteners, or at least 60 wt. %, or at least 70 wt. %, or at least 80 wt. %, or at least 90 wt. %. Optionally every sweetener ingredient is an organic sweetener. Optionally every sweetener ingredient is a natural sweetener. Optionally every sweetener ingredient is a steviol glycoside. Optionally every ingredient is an organic and/or natural ingredient, such that the reduced calorie (e.g., diet) carbonated cola beverage product is correspondingly an organic and/or natural beverage product.

It will be appreciated by those skilled in the art, given the benefit of the forgoing disclosure and the following further description of certain exemplary embodiments of the rebaudioside M sweetener compositions and rebaudioside M-sweetened food products, e.g., beverages and other beverage products disclosed here, that at least certain embodiments of the invention have improved or alternative formulations suitable to provide desirable taste profiles, nutritional characteristics, etc. These and other aspects, features and advantages of the invention or of certain embodiments of the invention will be further understood by those skilled in the art from the following description of exemplary embodiments.

### BRIEF DESCRIPTION OF THE DRAWINGS

The foregoing and other features and advantages of the present invention will be more fully understood from the following detailed description of illustrative embodiments taken in conjunction with the accompanying drawings in which:

FIG. 1 is a graph showing the presence of rebaudioside M in a commercial sample of Reb D;

FIG. 2A and FIG. 2B are liquid chromatography-mass spectroscopy (LCMS) spectrums for rebaudioside M;

FIG. 3 is a graph showing the nuclear magnetic resonance (NMR) spectrum for rebaudioside M; and

FIG. 4 is a differential scanning calorimetry graph for rebaudioside M.

### DETAILED DESCRIPTION OF CERTAIN EXEMPLARY EMBODIMENTS

It has been unexpectedly discovered that rebaudioside M can be used as a sweetener ingredient in a sweetener composition or food product, for example, as the sole sweetener ingredient or in combination with other sweetener ingredients in an aqueous solution, e.g., a diet acidic aqueous beverage with or without carbonation. Rebaudioside M has been discovered to provide significantly lower bitterness than the same concentration of other potent sweeteners such as rebaudioside A, for example when compared in otherwise identical formulations of acidic aqueous carbonated beverages. Further, rebaudioside M has been discovered to provide advantageous sweetening, and taste profile in beverages and other foods where it is used as the sole sweetener or in combination with other sweeteners. Notably, the use of rebaudioside M in combination with rebaudioside A (and optionally one or more other rebaudiosides and/or one or more other sweeteners) has been found to provide cost-effective sweetening without the expected bitterness typically associated with the use of rebaudioside A sweetener. For example, diet cola beverage products sweetened cost-effectively with a combination of rebaudioside M and rebaudioside A or sweetened with a combination of rebaudioside M, rebaudioside A and rebaudioside D (e.g., rebaudioside D and rebaudioside A in a 7:3 weight ratio) are surprisingly found to have advantageous sweetening and taste profile.

Various examples and embodiments of the inventive subject matter disclosed here are possible and will be apparent to persons of ordinary skill in the art, given the benefit of this disclosure. As used in this disclosure, the phrases “certain embodiments,” “certain exemplary embodiments,” “exemplary embodiments” and similar phrases mean that those embodiments are merely non-limiting examples of the inventive subject matter and that alternative or different embodiments are not being excluded. Unless otherwise indicated or unless otherwise clear from the context in which it is described, alternative elements or features in the embodiments and examples below and in the Summary above are interchangeable with each other. That is, an element described in one example or embodiment may be interchanged or substituted for one or more corresponding element(s) described in another example. Similarly, optional or non-essential features disclosed in connection with a particular embodiment or example should be understood to be disclosed for use in any other embodiments of the disclosed subject matter. More generally, the elements of the examples and exemplary embodiments should be understood to be disclosed generally for use with other aspects, embodiments and examples of the devices and methods disclosed herein. A reference to a component or ingredient being operative, i.e., able to perform one or more functions, tasks and/or operations or the like, is intended to mean that it can perform the expressly recited function(s), task(s) and/or operation(s) in at least certain embodiments, and may well be operative to perform also one or more other functions, tasks and/or operations. While this disclosure includes specific examples, including presently preferred modes or embodiments, those skilled in the art will appreciate that there are numerous variations and modifications within the spirit and scope of the invention as set forth in the appended claims. Each word and phrase used in the claims is intended to include all its dictionary meanings consistent with its usage in this disclosure and/or with its technical and industry usage in any relevant technology area. It should be understood that the term “about” is used throughout this disclosure and the appended claims to account for ordinary inaccuracy and variability, such as in measurement, testing and the like, in product production, etc.

As used in this disclosure, unless otherwise specified, the term “added” or “combined” and like terms means that the multiple ingredients or components referred to (e.g., oil, emulsifier, preservative, etc.) are combined in any manner and in any order, with or without stirring or the like, with or without heating, etc. For example, one or more ingredients can be dissolved into one or more other ingredients, or sprayed together, etc. As used here, a solution may be a true solution, a slurry, a suspension, or other form of liquid or flowable material. In certain embodiments, for example, materials may be said to be combined to form a homogenous solution.

Those of ordinary skill in the art will understand that in certain cases, for convenience, some ingredients are referred to or described here (including in the appended claims) by reference to the industry name for the product or to the original form of the ingredient in which it is used in formulating or producing the beverage or other food product. Such original form of the ingredient may differ from the form in which the ingredient is found in the finished beverage product. For example, the ingredient may be referred to in the form it is originally added during production of the food product rather than by the form it has in the finished food product, such as a dissolved or dissociated form or as a reaction product or complex with one or more of the other ingredients in the finished food product (or in an intermediate product in the course of producing the finished food product. Thus, for example, in certain exemplary embodiments of the beverage products according to this disclosure, sucrose and liquid sucrose would typically be substantially homogenously dissolved and dispersed in the comestible products. Likewise, other ingredients identified as a solid, concentrate (e.g., juice concentrate), etc. would typically be homogeneously dispersed throughout the beverage or throughout the beverage concentrate, rather than remaining in their original form. As another example, an ingredient described as a salt may exist in a beverage in dissolved form. Thus, reference to the form of an ingredient of a beverage product formulation should not be taken as a limitation on the form of the ingredient in the beverage product, but rather as a convenient means of describing the ingredient as an isolated component of the product formulation.

A leading text on stevia and steviol glycoside sweeteners, “Stevia, The genus Stevia”, edited by A. Douglas Kinghorn (2002), does not recognize or mention the existence of rebaudioside M. The molecular formula of rebaudioside M is C₅₆H₉₀O₃₃ and the molecular weight is 1291.3. It has CAS No. 1220616-44-3 and its appearance in a pure form (e.g., 98 wt. percent or more pure) is that of a white powder. It can be obtained from Jin Tan Natural Product MFR Co. Ltd. (City of Industry, Calif.). It is listed in US Patent Application Publication No. 2011/0183056 of Morita et al. (U.S. patent application Ser. No. 13/122,232) where it is said to have the structure:

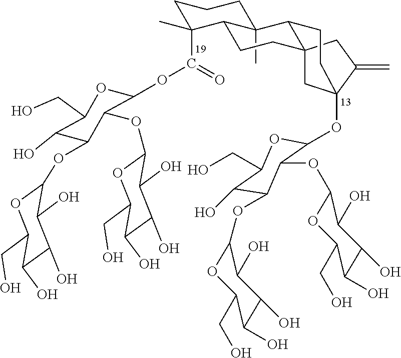 [SMILES: C=C1CC23CCC4C(C)(C(=O)OC5OC(CO)C(O)C(OC6OC(CO)C(O)C(O)C6O)C5OC5OC(CO)C(O)C(O)C5O)CCCC4(C)C2CCC1(OC1OC(CO)C(O)C(OC2OC(CO)C(O)C(O)C2O)C1OC1OC(CO)C(O)C(O)C1O)C3]

The structure may also be represented as:

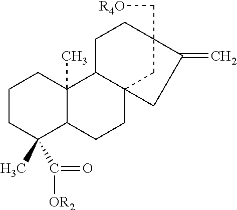

where moiety R₁ and moiety R₂ each has the structure:

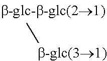

As noted above, it has been determined that rebaudioside A has off-tastes that have made its use as a sweetener problematic. The lingering bitter off taste of Reb A as a sweetener is perceptible and problematic, for example, in diet carbonated cola soft drinks where the caffeine and carbonation can contribute to the total bitterness. It has been surprisingly discovered that such beverage products, as well as sweetener compositions and other food products sweetened with rebaudioside M according to the invention exhibit a better taste profile than if sweetened with rebaudioside A. Likewise, rebaudioside M is found to provide a better taste profile for such foods and beverages than artificial sweeteners, such as aspartame, sucralose, cyclamates and the like. In certain embodiments of diet cola beverage sweetened with rebaudioside M, a sweetness was achieved close to that provided by sucrose.

As noted above, certain embodiments of the rebaudioside M-sweetened food products disclosed here are dry foods, such as, e.g., ready-to-eat cereals and other foods containing one or more grain constituents, gels, snack bars, etc. As used herein, the term “grain constituent” is intended to include any component of a whole grain, e.g., the whole grain kernel, the germ, the bran, the endosperm and any combination thereof. Whole grains typically refer to the germ, bran and endosperm of a grain, and may be milled, un-milled, etc. Refined grains typically refer to grain products in which the bran and most or all of the germ have been removed, leaving primarily or only the endosperm. A “grain constituent” may be, e.g., any combination of one or more components of a grain that have been ground into flour, cut into pieces of a variety of sizes or used whole. As used herein, the term “ready-to-eat cereal” refers to a grain product that may be eaten without the need for further preparation save for the optional addition of a liquid, such as, for example, milk, a milk substitute, juice or the like. As used herein, the term “snack” includes grain products that can be consumed from the packaging or container, optionally without further preparation. Snack grain products include, for example, snack bars such as, for example, grain bars, breakfast bars, granola bars (e.g., crunchy and/or soft), nutrition bars, diet bars and the like. The ready-to-eat grain products and/or snack grain products described herein can be fashioned into a variety of physical forms, such as, e.g., puffs, flakes, shreds, clusters, sheets and any combination thereof.

As used herein, the term “rebaudioside M present in a sweetening amount” in a beverage or other food product, and the alternative term “sweetening amount of rebaudioside M” refer to rebaudioside M being present in an amount sufficient to contribute sweetness perceptible in the food product to a sensory panel. That is, as used here these terms mean an amount or concentration that in the formulation of the food product in question causes sweetening that is perceptible to at least a majority of an expert sensory panel of the type commonly used in the food industry for making assessments of the taste properties of a beverage or other food. In the case of a syrup for producing a ready-to-drink beverage, e.g., a syrup suitable to be diluted by a 1-plus-5 throw with carbonated water to produce a ready-to-drink carbonated beverage, a sweetening amount is an amount or concentration in the syrup that yields perceptible sweetening of the ready-to-drink beverage. Such panels in the present context should comprise 8 to 12 individuals trained to evaluate sweetness perception and measure sweetness at several time points from when a sample is initially taken into the mouth until 3 minutes after it has been expectorated. For accuracy, each assessor may repeat the testing of each sample, e.g., from three to about five times per sample, with rinsing and a rest period of, e.g., five minute between each repetition and a rest period between each new and previous sample. Results may be determined using statistical analysis for comparing food samples of a particular formulation with the rebaudioside M ingredient to control food samples of the same formulation but without the rebaudioside M ingredient. “Perceptible sweetness” (and corresponding terms such as perceptible sweetening, etc.) as that term is used here may occur as sweetness in the test sample(s) with the rebaudioside M ingredient detected by at least a majority of the sensory panel at any time during the testing period. If some sweetness was detected in the samples without the rebaudioside M ingredient, then the perceptible sweetening may occur as a detected increase in sweetness in the test sample(s) with the rebaudioside M ingredient at a particular point in the testing time period or as detected sweetness at a point in time when it was not detected in the control sample(s). The panel of assessors may be trained using procedures well known to those of ordinary skill in the art, e.g., using the Spectrum™ Descriptive Analysis Method (Meilgaard et al, Sensory Evaluation Techniques, 3rd edition, Chapter 11).

As used herein, the term “total sweetening of the beverage product” includes the sweetness of the beverage product contributed by any and all sweetening ingredients. A “sweetening ingredient” as that term is used here, is one that is itself sweet and which itself contributes sweetness in the beverage product perceptible to a sensory panel (as described above). Accordingly, as used here, the percent of total sweetening contributed by a particular sweetener ingredient in a particular beverage or other food is determined based on the concentration and potency of that particular sweetener and the cumulative total corresponding value of all of the sweetening ingredients in the beverage or other food in question, ignoring any synergism that may occur between or among the sweeteners in the particular beverage or other food and ignoring the effect of any sweetness enhancer with the like that may be included in the particular formulation. Thus, the concentration times the potency of a particular sweetener is the numerator and the cumulative total of that value (concentration times potency) for all of the sweetener ingredients in the formulation is the denominator. The resulting value, expressed as a percentage, is the percent or percentage of total sweetening provided by the particular sweetener in question in the particular beverage or other food in question.

The food products disclosed here, including for example cola beverage products, optionally include rebaudioside M in an amount in which the rebaudioside M provides at least 10 percent of the total sweetening of the beverage product. Certain embodiments of the food products disclosed here, including, for example a cola beverage product, optionally include rebaudioside M in an amount such that the rebaudioside M is at least 10 weight percent of the total weight of sweetening ingredients in the beverage product. As used herein, the term “total weight of sweetening ingredients in the beverage product” includes the combined weight of the one or more sweetening ingredients (defined above) included in the beverage product. Certain embodiments include rebaudioside M with no other sweetening ingredients, certain embodiments include rebaudioside M with one other sweetening ingredient, and certain embodiments include rebaudioside M with more than one other sweetening ingredient. In certain such embodiments of the invention, the other sweetening ingredients comprise or consist essentially of one or more high intensity sweeteners. In certain such embodiments of the invention, nutritive sweeteners (e.g., sucrose) are excluded from the other sweetening ingredients.

As discussed above, other steviol glycosides, e.g., other rebaudiosides, e.g., rebaudioside A, rebaudioside D, stevioside, etc. can be used for sweetening in combination with Rebaudioside M sweetener in the cola beverage products and other beverage and other food products disclosed here. These compounds may be synthetically produced (e.g., chemically or by fermentation of genetically modified organisms, etc.) or obtained by extraction or the like from the stevia plant (e.g., by extraction followed by enzymatic conversion). Stevia (e.g., Stevia rebaudiana Bertoni) is a commercially cultivated, sweet-tasting plant. The leaves contain a complex mixture of natural sweet diterpene glycosides. Steviol glycosides and rebaudiosides are components of Stevia that contribute various degree of sweetness. Optionally, the sweetener compositions and the beverage products and other food products disclosed herein, including for example cola beverage products, may include one or more other steviol glycosides along with the rebaudioside M, e.g., rebaudioside A, rebaudioside B, rebaudioside C, rebaudioside D, rebaudioside E, stevioside, steviolbioside, dulcoside A, or mixtures of any two or more of them.

Processes for the preparation of certain rebaudiosides, including, e.g., rebaudioside D and also rebaudioside M and others, is shown in PCT patent application No. 104002121 filed Dec. 10, 2012 by Su Zhou Jing Hong Biotech Co., Ltd. (Wujiang, Jiangsu Province, People's Republic Of China) and corresponding U.S. provisional patent application No. 61/579,016 filed Dec. 22, 2011, the entire contents of which are hereby incorporated by reference herein. In accordance with various alternative embodiments of the beverages and other food products disclosed here, a sweetening amount of any one of the rebaudiosides shown in the aforesaid patent documents may optionally be used with rebaudioside M, e.g., any combination of two or more of them with or without other sweeteners.

In certain embodiments of the sweetener compositions, beverage products and other food products disclosed here, rebaudioside M sweetener is used together with a combination of rebaudiosides (optionally referred to as soluble rebaudioside D or soluble Reb D) comprising about 70 wt. % rebaudioside D and 30 wt. % rebaudioside A, perhaps with traces of other steviol glycosides or other compounds. Soluble Reb D is commercially available from Pure Circle Limited. It has been found that rebaudioside M in combination with soluble Reb D achieves cost-effective sweetening with a desirable taste profile in diet cola and other beverages and other foods. Surprisingly, substantial sweetening is obtained from the rebaudioside A component of the combination without incurring the unwanted lingering or bitter aftertaste typically associated with the use of rebaudioside A sweetener.

Extracts of Stevia leaves may be purified to concentrate a selected component of the stevia extract. Given the benefit of this disclosure, it will be within the ability of one of skill in the art to purify a Stevia rebaudiana extract to selectively isolate rebaudioside M. For example, column chromatography may be used to isolate rebaudioside M from the other steviol glycosides in a raw extract. Following chromatographic separation, rebaudioside M optionally is recrystallized at least once or multiple times to obtain a stevia extract comprising a desired level of purity of rebaudioside M. In certain embodiments of the invention, a purified stevia extract used as the rebaudioside M sweetener disclosed here has a purity of 93% or greater rebaudioside M, or at least 94%, or at least 95%, or at least 96%, or at least 97%, or at least 98%, or at least 99% by weight. In certain exemplary embodiments the rebaudioside M sweetener is obtained by purification of an extract from a cultivar of stevia having a naturally higher content of rebaudioside M.

In addition to rebaudioside M, optionally one or more additional sweeteners may be included in the beverage products disclosed here, including for example cola beverage products. Such optional additional sweeteners include natural and artificial or synthetic sweeteners. Suitable sweeteners and combinations of sweeteners are selected for the desired nutritional characteristics, taste profile for the beverage, mouthfeel and other organoleptic factors. According to certain exemplary embodiments of the beverage products disclosed here, including for example cola beverage products, the total weight of sweetening ingredients comprises at least 10.0% by weight rebaudioside M. Certain exemplary embodiments of the beverage products disclosed here (e.g., cola beverage products) comprise rebaudioside M in an amount of at least 20% by weight of the total weight of sweetening ingredients. Certain exemplary embodiments of the beverage products disclosed here (e.g., cola beverage products) comprise rebaudioside M in an amount of at least 25% by weight of the total weight of sweetening ingredients. Certain exemplary embodiments of the beverage products disclosed here (e.g., cola beverage products) comprise rebaudioside M in an amount of at least 30% by weight of the total weight of sweetening ingredients. Certain exemplary embodiments of the beverage products disclosed here (e.g., cola beverage products) comprise rebaudioside M in an amount of at least 40% by weight of the total weight of sweetening ingredients. Certain exemplary embodiments of the beverage products disclosed here (e.g., cola beverage products) comprise rebaudioside M in an amount of at least 50% by weight of the total weight of sweetening ingredients. Certain exemplary embodiments of the beverage products disclosed here (e.g., cola beverage products) comprise rebaudioside M in an amount of at least 60% by weight of the total weight of sweetening ingredients. Certain exemplary embodiments of the beverage products disclosed here (e.g., cola beverage products) comprise rebaudioside M in an amount of at least 70% by weight of the total weight of sweetening ingredients. Certain exemplary embodiments of the beverage products disclosed here (e.g., cola beverage products) comprise rebaudioside M in an amount of at least 75% by weight of the total weight of sweetening ingredients. Certain exemplary embodiments of the beverage products disclosed here (e.g., cola beverage products) comprise rebaudioside M in an amount of at least 80% by weight of the total weight of sweetening ingredients. Certain exemplary embodiments of the beverage products disclosed here (e.g., cola beverage products) comprise rebaudioside M in an amount of at least 90% by weight of the total weight of sweetening ingredients. Certain exemplary embodiments of the beverage products disclosed here (e.g., cola beverage products) comprise rebaudioside M in an amount of at least 95% by weight of the total weight of sweetening ingredients. Certain exemplary embodiments of the beverage products disclosed here (e.g., cola beverage products) comprise rebaudioside M in an amount of at least 99% by weight of the total weight of sweetening ingredients.

For instance, in certain embodiments the sweetening ingredients in the beverage product (e.g., a cola beverage product) consist of both rebaudioside M and one or more other high intensity sweeteners, such as rebaudioside A, rebaudioside B, rebaudioside C, rebaudioside D, rebaudioside E, monatin, thaumatin, monellin, brazzein, L-alanine, glycine, Lo Han Guo (e.g., Lo Han Guo juice concentrate, mogrosides, etc.), hernandulcin, phyllodulcin, trilobtain, or a combinations of any two or more of them. In such embodiments, the sweetening ingredients may consist of from 20% by weight to 99.9% by weight rebaudioside M and from 0.1% by weight to 80% by weight (cumulative total) of the other high intensity sweeteners. In other embodiments, the sweetening ingredients may consist of from 50% by weight to 99.9% by weight rebaudioside M and from 0.1% by weight to 50% by weight of the other high intensity sweeteners, or from 80% by weight to 99.9% by weight rebaudioside M and from 0.1% by weight to 20% by weight of other high intensity sweeteners. Moreover, the ratio of rebaudioside M to other high intensity sweeteners may in certain embodiments comprise any blend from 1:5 and 99:1 rebaudioside M to the cumulative total of the other high intensity sweeteners.

According to certain embodiments of the beverage products disclosed here, including for example cola beverage products, the products include rebaudioside M in an amount in which the rebaudioside M provides at least 10 percent of the total sweetening of the beverage product. Certain exemplary embodiments of the beverage products disclosed here (e.g., cola beverage products) comprise rebaudioside M in an amount providing at least 20% of the total sweetening of the beverage product. Certain exemplary embodiments of the beverage products disclosed here (e.g., cola beverage products) comprise rebaudioside M in an amount providing at least 25% of the total sweetening of the beverage product. Certain exemplary embodiments of the beverage products disclosed here (e.g., cola beverage products) comprise rebaudioside M in an amount providing at least 30% of the total sweetening of the beverage product. Certain exemplary embodiments of the beverage products disclosed here (e.g., cola beverage products) comprise rebaudioside M in an amount providing at least 40% of the total sweetening of the beverage product. Certain exemplary embodiments of the beverage products disclosed here (e.g., cola beverage products) comprise rebaudioside M in an amount providing at least 50% of the total sweetening of the beverage product. Certain exemplary embodiments of the beverage products disclosed here (e.g., cola beverage products) comprise rebaudioside M in an amount providing at least 60% of the total sweetening of the beverage product. Certain exemplary embodiments of the beverage products disclosed here (e.g., cola beverage products) comprise rebaudioside M in an amount providing at least 70% of the total sweetening of the beverage product. Certain exemplary embodiments of the beverage products disclosed here (e.g., cola beverage products) comprise rebaudioside M in an amount providing at least 75% of the total sweetening of the beverage product. Certain exemplary embodiments of the beverage products disclosed here (e.g., cola beverage products) comprise rebaudioside M in an amount providing at least 80% of the total sweetening of the beverage product. Certain exemplary embodiments of the beverage products disclosed here (e.g., cola beverage products) comprise rebaudioside M in an amount providing at least 90% of the total sweetening of the beverage product. Certain exemplary embodiments of the beverage products disclosed here (e.g., cola beverage products) comprise rebaudioside M in an amount providing at least 95% of the total sweetening of the beverage product. Certain exemplary embodiments of the beverage products disclosed here (e.g., cola beverage products) comprise rebaudioside M in an amount providing at least 99% of the total sweetening of the beverage product.

For instance, in certain embodiments in which the beverage product (e.g., a cola beverage product) includes both rebaudioside M and one or more other sweeteners, such as rebaudioside A, rebaudioside D, sucrose, monatin, thaumatin, monellin, brazzein, L-alanine, glycine, Lo Han Guo (e.g., Lo Han Guo juice concentrate, mogrosides, etc.), hernandulcin, phyllodulcin, trilobtain, or a combination of any of them, from 20% to 99.9% of the total sweetening of the beverage product optionally may be provided by rebaudioside M and from 0.1% to 80% of the total sweetening may be provided by other sweeteners, or from 50% to 99.9% of the total sweetening of the beverage product provided by rebaudioside M and from 0.1% to 50% of the total sweetening provided by other sweeteners, or from 80% to 99.9% of the total sweetening of the beverage product provided by rebaudioside M and from 0.1% to 20% of the total sweetening provided by other sweeteners. Moreover, the ratio of sweetening provided by rebaudioside M to the sweetening provided by other sweeteners in such a beverage product may be any selected ratio from 1:5 and 99:1 sweetening provided by rebaudioside M: sweetening provided by other sweeteners. It should be understood that reference in this disclosure to the sweetness or sweetening provided by rebaudioside M or by another sweetener means the sweetening provided in the context of the beverage product in question (e.g., a cola beverage product). Thus, for example, the sweetness or sweetening provided by the rebaudioside M content of a particular beverage formulation means the sweetness or sweetening provided by the rebaudioside M including any sweetness enhancing effect caused by other ingredients of the beverage. Likewise, the sweetening provided by another sweetener included in that beverage formulation means the sweetening provided by that sweetener including any sweetness enhancing effect caused by other ingredients of the beverage.

According to certain embodiments of the invention, in addition to rebaudioside M, a beverage product (e.g., a cola beverage product) containing rebaudioside M, comprises one or more other suitable ingredients, for example but without limitation, any one or more preservatives, taste modifiers or maskers, flavoring agents, other constituents extracted with the rebaudioside M, or a combination of any of these and/or other ingredients suitable for consumption. Other sweeteners optionally included in a beverage product containing Rebaudioside M according to this disclosure include, e.g., any one or more natural or synthetic sweeteners. Such other included sweeteners may be potent sweeteners (i.e., at least twice as sweet as sucrose) or non-potent sweeteners. For example, such other sweeteners typically may be one or more other steviol glycosides extracted with the rebaudioside M, sucrose, one or more sweeteners such as thaumatin, monatin, monellin, brazzein, L-alanine, glycine, Lo Han Guo, hernandulcin, phyllodulcin, and trilobtain, or a combination of any of them.

In certain exemplary embodiments, ready-to-drink beverage products (e.g., cola beverage products) are provided comprising water and Rebaudioside M as disclosed here, where rebaudioside M is present in the beverage in an amount (i.e., a concentration) of from 100 ppm to 1200 ppm rebaudioside M in the beverage, e.g., from 360 ppm to 600 ppm. Optionally, the beverage product further comprises one or more ingredients selected from the group consisting of acidulants, fruit juices and/or vegetable juices, pulp, etc., flavorings, color, preservative, vitamins, minerals, electrolytes, erythritol, D-tagatose, D-psicose, glycerine, and carbon dioxide. Such ingredients are further described below. According to certain exemplary embodiments, the beverage product is a beverage concentrate, that is, a beverage product to be diluted to form a ready-to-drink beverage.

In some embodiments of the invention, a beverage product, including for example a cola beverage product, is provided comprising water, acidulant comprising at least one acid, and rebaudioside M as disclosed here. In certain exemplary embodiments of such beverage products, the rebaudioside M may consist essentially of a stevia extract, e.g., a natural extract from stevia plant leaves. In certain exemplary embodiments such a natural extract has been purified to have a purity of at least 80 wt. %, at least 90 wt. %, at least 93 wt. %, at least 95 wt. %, at least 97 wt. %, at least 98 wt. % or at least 99 wt. % rebaudioside M. In certain exemplary embodiments the beverage product comprises a purity of at least 93 wt. % rebaudioside M, or even at least 95 wt. % rebaudioside M, at least 97 wt. % rebaudioside M, or at least 99 wt. % rebaudioside M. Optionally, the Rebaudioside M is present in the beverage (e.g., a cola beverage) in an amount sufficient to provide rebaudioside M in a concentration of between 50 ppm and 1500 ppm in the beverage, such as from 200 ppm to 600 ppm.

Certain exemplary embodiments of the beverage products (e.g., cola beverage products) further comprise one or more other suitable beverage ingredients, for example, fruit juices and/or vegetable juices, pulp, etc., flavorings, color, preservative, vitamins, minerals, electrolytes, erythritol, D-tagatose, D-psicose, glycerine, and carbon dioxide, as further described below. Such beverage products may be provided in any suitable form, such as a beverage concentrate or a carbonated, ready-to-drink beverage.

Certain exemplary embodiments of the rebaudioside M sweetener compositions disclosed here comprise one or more other suitable beverage ingredients, for example, one or more bulking agents. The bulking agent may be, e.g., maltodextrin, polydextrose, a dextrin, inulin, an oligosaccharide, beta-glucan, a resistant starch, a hydrocolloid and a corn syrup solid. The hydrocolloid may be: for example, gum Arabic, pectin, guar gum, alginate, carrageenan, xanthan gum, cellulose gum or a combination of two or more of any of them.

According to embodiments of the invention, a natural beverage product (e.g., a natural cola beverage product) is provided comprising water, acidulant comprising at least one acid, and a stevia extract having (either as originally extracted or as then purified) a purity of at least 40 wt. % rebaudioside M, e.g., at least 50 wt. %, at least 60 wt. %, at least 70 wt. %, at least 80 wt. %, at least 90 wt. %, or at least 95 wt. % rebaudioside M. According to certain exemplary embodiments, such natural beverage products further comprise one or more other beverage ingredients, as further described below.

Certain aspects of this disclosure relate to the “concentration” of a solution, which is taken to mean the amount of solute in a given amount of solvent or solution. There are many ways to express concentration. For example, concentration may be defined in units of mass per unit volume (e.g., mg/mL, mg/cm³ and the like), percent by mass (which is simply the mass of the solute divided by the total mass of the solution multiplied by 100% (e.g., weight percent, percent by weight, wt. percent, wt. %, w/w, and the like)), percent by volume (which is simply the volume of the solute divided by the sum of the volumes of the other components multiplied by 100% (e.g., volume percent, percent by volume, v/v, and the like)), molarity (which is the number of moles of solute dissolved in one liter of solution), molality (which is the number of moles of solute dissolved in one kilogram of solvent), and parts per million (milligrams per liter).

It should be understood that sweetener compositions, beverages and other food products in accordance with this disclosure may have any of numerous different specific formulations or constitutions. The formulation may vary depending upon such factors as the product's intended market segment, its desired nutritional characteristics, flavor profile and the like. Additional (i.e., more and/or other) sweeteners may be added, flavorings, electrolytes, vitamins, fruit juices or other fruit products, tastents, masking agents and the like, flavor enhancers, and/or carbonation typically may be added to any such formulations to vary the taste, mouthfeel, nutritional characteristics, etc. In general, a rebaudioside M-sweetened beverage product in accordance with this disclosure, including for example a cola beverage product, typically comprises at least water, rebaudioside M, acidulant and flavoring. Exemplary flavorings which may be suitable for at least certain formulations in accordance with this disclosure include cola flavoring, citrus flavoring, spice flavorings and others. Carbonation in the form of carbon dioxide may be added for effervescence. Preservatives may be added if desired, depending upon the other ingredients, production technique, desired shelf life, etc. Optionally, caffeine may be added. Certain exemplary embodiments of the beverages disclosed here are cola-flavored carbonated beverages, characteristically containing carbonated water, sweetener, kola nut extract and/or other flavoring, caramel coloring, at least one acid, and optionally other ingredients. Additional and alternative suitable ingredients will be recognized by those skilled in the art given the benefit of this disclosure.

The beverage products disclosed here include, for example, beverage products, e.g., ready-to-drink liquid formulations, beverage concentrates or syrups, and the like. As used herein, the term “ready-to-drink” refers to a beverage that can be ingested as-is. That is, the ready-to-drink beverage requires no dilution or additions prior to ingestion by a consumer. Ready-to-drink beverage products include, e.g., carbonated and non-carbonated soft drinks, fountain beverages, carbonated and non-carbonated frozen ready-to-drink beverages, coffee beverages, tea beverages, dairy beverages, powdered soft drinks, as well as liquid concentrates, flavored waters, enhanced waters, fruit juice and fruit juice-flavored drinks, sport drinks, and alcoholic products Ready-to-drink low calorie, frozen beverages sweetened by rebaudioside M in accordance with one aspect of this disclosure can be prepared directly or from a concentrate syrup. Optionally the formulation may include flavoring, low potency sweetener, preservative and/or other suitable ingredients. To prepare low calorie frozen beverages sweetened by rebaudioside M from a concentrate syrup, the pre-made syrup can be diluted with water, e.g. in a 1-plus-5 throw, to produce a beverage mixture. The beverage mixture can be poured into the hopper of a frozen beverage unit (e.g. a Taylor 428 or 430 frozen beverage unit or an Ultra I or Ultra II frozen beverage unit) to generate and dispense frozen carbonated beverage. Alternatively, the water and syrup can be combined at the point of dispensing. Optionally the frozen carbonated beverage can be flavored after being dispensed by adding flavored syrup.

Frozen carbonated beverage embodiments in accordance with one aspect of the present disclosure, for example, low calorie embodiments and diet embodiments, can be prepared directly as ready-to-drink beverages or as syrup to be held in a frozen carbonated beverage machine (optionally referred to here as an “FCB Dispenser”) configured to hold the syrup at reduced temperature and to add carbonated water to the syrup and dispense ready-to-drink frozen carbonated beverage at the time of consumption. Suitable FCB Dispensers are known to those skilled in the art and include, for example, the Cornelius V3 model and newer versions available from IMI Cornelius, Inc., a subsidiary of IMI plc. For example, beverage syrup for frozen carbonated beverages can be prepared by combining the ingredients of a CSD flavor base with one or more bulking agents and/or other ingredients. For example, erythritol (e.g., up to 3.5% by weight of finished beverage), D-Psicose (e.g., up to 2.1% by weight of finished beverage), and/or D-tagatose (e.g., up to 3.0 wt. % of finished beverage) can be added to a sweetened or unsweetened CSD base containing water, flavoring, preservative, etc. (e.g., cola CSD base or lemon-lime CSD base) or other beverage base with stirring to achieve some or complete dissolution. Rebaudioside M is added at any suitable point, e.g., prior to or after adding the other ingredients mentioned above, e.g., 500 ppm of finished beverage, with stirring for partial or complete dissolution. The syrup can be placed into a frozen carbonated beverage machine (“FCB Dispenser”) configured to add carbonated water to the syrup before or at the time of dispensing servings of finished ready-to-drink diet frozen carbonated beverage. Ready-to-drink servings of finished frozen carbonated beverage should have good carbon dioxide overrun, smooth, creamy mouthfeel and good taste profile. Optionally frozen carbonated beverage syrup can be successively run through the FCB Dispenser to achieve consistently high quality ready-to-drink servings of finished frozen carbonated beverage.

In certain exemplary embodiments of the ready-to-drink beverages disclosed here, including for example a ready-to-drink diet cola beverage, the beverage product comprises at least about 50 ppm rebaudioside M. Certain exemplary embodiments of the ready-to-drink beverages disclosed here comprise from about 50 ppm to about 600 ppm rebaudioside M, e.g., about 100 ppm, about 200 ppm, about 300 ppm, about 400 ppm, about 500 ppm. Correspondingly higher concentrations of rebaudioside M are used in beverage concentrates or syrups, e.g., from about 100 ppm to 500 ppm or to the solubility limit of Rebaudioside M in the formulation.

According to certain embodiments of the beverage concentrates disclosed here, including for example cola beverage concentrates, the beverage concentrates include rebaudioside M in an amount in which the rebaudioside M provides at least 10 percent of the total sweetening of the beverage concentrate. Certain exemplary embodiments of the beverage concentrates disclosed here (e.g., cola beverage concentrates) comprise rebaudioside M in an amount providing at least 20% of the total sweetening of the beverage concentrate. Certain exemplary embodiments of the beverage concentrates disclosed here (e.g., cola beverage concentrates) comprise rebaudioside M in an amount providing at least 25% of the total sweetening of the beverage concentrate. Certain exemplary embodiments of the beverage concentrates disclosed here (e.g., cola beverage concentrates) comprise rebaudioside M in an amount providing at least 30% of the total sweetening of the beverage concentrate. Certain exemplary embodiments of the beverage concentrates disclosed here (e.g., cola beverage concentrates) comprise rebaudioside M in an amount providing at least 40% of the total sweetening of the beverage concentrate. Certain exemplary embodiments of the beverage concentrates disclosed here (e.g., cola beverage concentrates) comprise rebaudioside M in an amount providing at least 50% of the total sweetening of the beverage concentrate. Certain exemplary embodiments of the beverage concentrates disclosed here (e.g., cola beverage concentrates) comprise rebaudioside M in an amount providing at least 60% of the total sweetening of the beverage concentrate. Certain exemplary embodiments of the beverage concentrates disclosed here (e.g., cola beverage concentrates) comprise rebaudioside M in an amount providing at least 70% of the total sweetening of the beverage concentrate. Certain exemplary embodiments of the beverage concentrates disclosed here (e.g., cola beverage concentrates) comprise rebaudioside M in an amount providing at least 75% of the total sweetening of the beverage concentrate. Certain exemplary embodiments of the beverage concentrates disclosed here (e.g., cola beverage concentrates) comprise rebaudioside M in an amount providing at least 80% of the total sweetening of the beverage concentrate. Certain exemplary embodiments of the beverage concentrates disclosed here (e.g., cola beverage concentrates) comprise rebaudioside M in an amount providing at least 90% of the total sweetening of the beverage concentrate. Certain exemplary embodiments of the beverage concentrates disclosed here (e.g., cola beverage concentrates) comprise rebaudioside M in an amount providing at least 95% of the total sweetening of the beverage concentrate. Certain exemplary embodiments of the beverage concentrates disclosed here (e.g., cola beverage concentrates) comprise rebaudioside M in an amount providing 100%? Of the total sweetening of the beverage concentrate.

In certain exemplary embodiments of the rebaudioside M-sweetened syrups disclosed here, the syrup comprises (subject to its solubility limit in the particular formulation) at least about 1000 ppm, about 1500 ppm, about 2000 ppm, about 2500 ppm, about 3000 ppm, about 3500 ppm, about 4000 ppm, about 4500 ppm or about 5000 ppm rebaudioside M. The terms “beverage concentrate,” “throw beverage syrup” and “syrup” are used interchangeably throughout this disclosure. At least certain exemplary embodiments of the beverage concentrates contemplated are prepared with an initial volume of water to which the additional ingredients are added. A single strength beverage composition (i.e., a beverage composition at a concentration that is ready-to-drink) may be formed from the beverage concentrate or syrup by adding further volumes of water to the concentrate to dilute it to a single strength. Typically, for example, single strength beverages, including for example, carbonated cola beverages, may be prepared from the concentrates by combining approximately 1 part concentrate with between approximately 3 to approximately 32 parts water, e.g., about five parts water to one part concentrate in some commercial beverage bottling operations, or as much as 32 parts water to one part concentrate in some fountain operations (referred to in some cases as super fountain formulations). In certain exemplary embodiments a single strength beverage is prepared by combining 1 part concentrate with 5 parts water, that is, the concentrate or syrup is prepared for use in a so called 1-plus-5 throw dilution operation. In certain exemplary embodiments the additional water used to form the single strength beverages is carbonated water. In certain other embodiments, a single strength beverage is directly prepared without the formation of a concentrate and subsequent dilution.

Natural embodiments of the beverage products disclosed here are natural in that they do not contain anything artificial or synthetic (including any color additives regardless of source) that would not normally be expected to be in the food. As used herein, therefore, a “natural” beverage composition is defined in accordance with the following guidelines: Raw materials for a natural ingredient exists or originates in nature. Biological synthesis involving fermentation and enzymes can be employed, but synthesis with chemical reagents is not utilized. Artificial colors, preservatives, and flavors are not considered natural ingredients. Ingredients may be processed or purified through certain specified techniques including at least: physical processes, fermentation, and enzymolysis. Appropriate processes and purification techniques include at least: absorption, adsorption, agglomeration, centrifugation, chopping, cooking (baking, frying, boiling, roasting), cooling, cutting, chromatography, coating, crystallization, digestion, drying (spray, freeze drying, vacuum), evaporation, distillation, electrophoresis, emulsification, encapsulation, extraction, extrusion, filtration, fermentation, grinding, infusion, maceration, microbiological (rennet, enzymes), mixing, peeling, percolation, refrigeration/freezing, squeezing, steeping, washing, heating, mixing, ion exchange, lyophilization, osmose, precipitation, salting out, sublimation, ultrasonic treatment, concentration, flocculation, homogenization, reconstitution, enzymolysis (using enzymes found in nature). Processing aids (currently defined as substances used as manufacturing aids to enhance the appeal or utility of a food component, including clarifying agents, catalysts, flocculants, filter aids, and crystallization inhibitors, etc. See 21 CFR §170.3(o)(24)) are considered incidental additives and may be used if removed appropriately.

Substantially clear embodiments of the beverage products disclosed here are substantially clear in that the beverages have substantially no turbidity and substantially no color.

Water is a basic ingredient in the products disclosed here, including for example cola beverage products, typically being the vehicle or primary liquid portion in which the Rebaudioside M is provided and the remaining ingredients in the beverage products are dissolved, emulsified, suspended or dispersed. Purified water can be used in the manufacture of certain embodiments of the beverage products disclosed here, and water of a standard beverage quality can be employed in order not to adversely affect beverage taste, odor, or appearance. The water typically will be clear, colorless, free from objectionable minerals, tastes and odors, free from organic matter, low in alkalinity and of acceptable microbiological quality based on industry and government standards applicable at the time of producing the beverage. In certain typical embodiments of beverage products, water is present at a level of from about 80% to about 99.9% by weight of the beverage. In at least certain exemplary embodiments the water used in beverages and concentrates disclosed here is “treated water,” which refers to water that has been treated to reduce the total dissolved solids of the water prior to optional supplementation, e.g., with calcium as disclosed in U.S. Pat. No. 7,052,725. Methods of producing treated water are known to those of ordinary skill in the art and include deionization, distillation, filtration and reverse osmosis (“r-o”), among others. The terms “treated water,” “purified water,” “demineralized water,” “distilled water,” and “r-o water” are understood to be generally synonymous in this discussion, referring to water from which substantially all mineral content has been removed, typically containing no more than about 500 ppm total dissolved solids, e.g. 250 ppm total dissolved solids.

As used herein, “taste” refers to a combination of sweetness perception, temporal effects of sweetness perception, i.e., on-set and duration, off-tastes, e.g. bitterness and metallic taste, residual perception (aftertaste) and tactile perception, e.g. body and thickness. As used herein, a “full-calorie” beverage formulation is one fully sweetened with a nutritive sweetener. The term “nutritive sweetener” refers generally to sweeteners which provide significant caloric content in typical usage amounts, e.g., more than about 5 calories per 8 oz. serving of beverage. As used herein, a “potent sweetener” means a sweetener which is at least twice as sweet as sugar, that is, a sweetener which on a weight basis requires no more than half the weight of sugar to achieve an equivalent sweetness. For example, a potent sweetener may require less than one-half the weight of sugar to achieve an equivalent sweetness in a beverage sweetened to a level of 10 degrees Brix with sugar. Potent sweeteners include both nutritive (e.g., Lo Han Guo juice concentrate) and non-nutritive sweeteners (e.g., typically, Lo Han Guo powder). In addition, potent sweeteners include both natural potent sweeteners (e.g., steviol glycosides, Lo Han Guo, etc.) and artificial potent sweeteners (e.g., neotame, etc.). However, for natural beverage products disclosed here, only natural potent sweeteners are employed.

Sweeteners suitable for combination with rebaudioside M in at least certain exemplary embodiments of beverage products disclosed here (e.g., cola beverage products) include, for example, sugar alcohols such as erythritol, sorbitol, mannitol, xylitol, lactitol, isomalt, and malitol. Other sweeteners include D-psicose, D-tagatose, combination of D-psicose with the sugar alcohol erythritol and combination of D-tagatose and D-psicose with the sugar alcohol erythritol. As further discussed below, exemplary natural nutritive sweeteners suitable for some or all embodiments of the beverage products disclosed here, including for example cola beverage products, include crystalline or liquid sucrose, fructose, glucose, dextrose, maltose, trehalose, fructo-oligosaccharides, glucose-fructose syrup from natural sources such as apple, chicory, honey, etc., e.g., high fructose corn syrup, invert sugar and the like and mixtures of any of them; exemplary artificial sweeteners suitable for some or all embodiments of the beverages disclosed here include sucralose, saccharin, cyclamate, aspartame, other dipeptide esters, acesulfame potassium, and other such potent sweeteners, and mixtures of any of them; and exemplary natural non-nutritive potent sweeteners suitable for some or all embodiments of the beverages including rebaudioside M disclosed here include steviol glycosides (e.g., stevioside, steviolbioside, dulcoside A, rebaudioside A, rebaudioside B, rebaudioside C, rebaudioside D, rebaudioside E, mixtures of any of them, etc.) and Lo Han Guo and related compounds, and mixtures of any of them. Also, in at least certain exemplary embodiments of the beverage products disclosed here (e.g., cola beverage products), combinations of rebaudioside M with one or more natural nutritive sweeteners, one or more artificial sweeteners and/or one or more natural non-nutritive potent sweeteners are used to provide the sweetness and other aspects of desired taste profile and nutritive characteristics. It should also be recognized that certain such sweeteners will, either in addition or instead, act as tastents, masking agents or the like in various embodiments of the beverages disclosed here, e.g., when used in amounts below its (or their) sweetness perception threshold in the beverage in question. For instance, in certain embodiments comprising both erythritol and D-psicose in a beverage or other food sweetened with rebaudioside M in combination with rebaudioside A as a sweetener (alone or with yet other sweeteners, e.g., rebaudioside D), erythritol is found to act as a bitterness masking or reducing agent and D-psicose is found to improve the upfront sweetness of formulation.

The sweeteners included in the formulations of the beverage products disclosed here, including for example cola beverage products, are edible consumables suitable for consumption and for use in beverages. By “edible consumables” is meant a beverage or an ingredient of a beverage for human or animal consumption. The sweetener or sweetening agent used here and in the claims may be a nutritive or non-nutritive, natural or synthetic beverage ingredient or additive (or mixtures of them) which provides sweetness to the beverage, i.e., which is perceived as sweet by the sense of taste. The perception of flavoring agents and sweetening agents may depend to some extent on the interrelation of elements. Flavor and sweetness may also be perceived separately, i.e., flavor and sweetness perception may be both dependent upon each other and independent of each other. For example, when a large amount of a flavoring agent is used, a small amount of a sweetening agent may be readily perceptible and vice versa. Thus, the oral and olfactory interaction between a flavoring agent and a sweetening agent may involve the interrelationship of elements.

In at least certain exemplary embodiments of beverage products disclosed here, including for example cola beverage products, the sweetener component may include as an optional additional sweetener, nutritive, natural crystalline or liquid sweeteners such as sucrose, liquid sucrose, fructose, liquid fructose, glucose, liquid glucose, glucose-fructose syrup from natural sources such as apple, chicory, honey, etc., e.g., high fructose corn syrup, invert sugar, maple syrup, maple sugar, honey, brown sugar molasses, e.g., cane molasses, such as first molasses, second molasses, blackstrap molasses, and sugar beet molasses, sorghum syrup, and/or others. Such sweeteners are present in at least certain exemplary embodiments in an amount of from about 0.1% to about 20% by weight of the beverage, such as from about 6% to about 16% by weight, depending upon the desired level of sweetness for the beverage product. To achieve desired uniformity, texture and taste, in certain exemplary embodiments of the natural beverage products disclosed here, standardized liquid sugars as are commonly employed in the food industry can be used. Typically such standardized sweeteners are free of traces of non-sugar solids which could adversely affect the flavor, color or consistency of the beverage product.

The term “nutritive sweetener” refers generally to sweeteners which provide significant caloric content in typical usage amounts, e.g., more than about 5 calories per 8 oz. serving of beverage. As used herein, a “full-calorie” beverage formulation is one fully sweetened with a nutritive sweetener. As used herein, a “non-nutritive sweetener” is one which does not provide significant caloric content in typical usage amounts, i.e., is one which imparts less than 5 calories per 8 oz. serving of beverage to achieve the sweetness equivalent of 10 Brix of sugar. As used herein, “reduced calorie beverage” means a beverage having at least a 25% reduction in calories per

8 oz. serving of beverage as compared to the full calorie version, typically a previously commercialized full-calorie version. In at least certain embodiments, a reduced calorie beverage has about a 50% reduction in calories per 8 oz. serving as compared to the full calorie version. As used herein, a “low-calorie beverage” has fewer than 40 calories per 8 oz. serving of beverage. As used herein, “zero-calorie” or “diet” means having less than 5 calories per serving, e.g., per 8 oz. for beverages.

Artificial and natural non-nutritive potent sweeteners are suitable for inclusion as supplementary sweetener in at least certain exemplary embodiments of the beverage products disclosed here (e.g., cola beverages), or in a beverage comprising rebaudioside M and optionally other ingredients, such as acidulant comprising, e.g., at least one acid disclosed here. Such artificial potent sweeteners include, for example, peptide based sweeteners, for example, aspartame, neotame, and alitame, and non-peptide based sweeteners, for example, sodium saccharin, calcium saccharin, acesulfame potassium, sodium cyclamate, calcium cyclamate, neohesperidin dihydrochalcone, and sucralose. In certain exemplary embodiments, a beverage product comprising rebaudioside M further comprises a supplementary sweetener, for example, aspartame, either alone or with one or more other supplementary sweeteners. In certain other exemplary embodiments the supplementary sweetener comprises or consists essentially of aspartame and acesulfame potassium. Natural non-nutritive potent sweeteners suitable for use in at least certain embodiments as a supplementary sweetener for the rebaudioside M include, for example, other steviol glycosides (e.g., stevioside, steviolbioside, dulcoside A, rebaudioside A, rebaudioside B, rebaudioside C, rebaudioside D, rebaudioside E, mixtures of any of them, etc.), Lo Han Guo and related compounds, as discussed further below. Non-nutritive, high potency sweeteners typically are employed in beverages disclosed here, including for example cola beverages, at a level of milligrams per fluid ounce of beverage, according to their sweetening power, any applicable regulatory provisions of the country where the beverage is to be marketed, the desired level of sweetness of the beverage, etc. It will be within the ability of those skilled in the art, given the benefit of this disclosure, to select suitable additional or alternative sweeteners for use with rebaudioside M in various embodiments of the beverage products disclosed here.

The sweetener Lo Han Guo, which has various different spellings and pronunciations, may be used as a supplementary sweetener in certain exemplary embodiments of Rebaudioside M disclosed here, and in at least certain beverages comprising Rebaudioside M (e.g., cola beverage products). Lo Han Guo may be obtained from fruit of the plant family Cucurbitaceae, tribe Jollifieae, subtribe Thladianthinae, genus Siraitia. Lo Han Guo often is obtained from the genus/species S. grosvenorii, S. siamensis, S. silomaradjae, S. sikkimensis, S. africana, S. borneensis, and S. taiwaniana. Suitable fruit includes that of the genus/species S. grosvenorii, which is often called Luo Han fruit. Lo Han Guo contains triterpene glycosides or mogrosides, which constituents may be used as Lo Han Guo sweeteners. Luo Han Guo may be used as the juice or juice concentrate, powder, etc. LHG juice concentrate may contain about 3 wt. % to about 12 wt. %, e.g., about 6 wt. % mogrosides, such as mogroside V, mogroside IV, (11-oxo-mogroside V), siamenoside and mixtures thereof. Lo Han Guo may be produced, for example, as discussed in U.S. Pat. No. 5,411,755. Sweeteners from other fruits, vegetables or plants also may be used as natural or processed sweeteners or sweetness enhancers in at least certain exemplary embodiments of the beverage products disclosed here.

Other sweeteners suitable for use as a supplementary sweetener in at least certain exemplary embodiments of the beverage products disclosed here (e.g., cola beverage products), and in at least certain beverages comprising rebaudioside M include glycyrrhizin, neohesperidin dihydrochalcone, lactose, xylose, arabinose and ribose, and sweeteners such as thaumatin, monatin, monellin, brazzein, L-alanine, glycine, Lo Han Guo, hernandulcin, phyllodulcin, and trilobtain.

Certain aspects of the present invention pertain to stirring the liquids, beverages, beverage products and various other components described herein. The term “mixing,” as used herein includes, but is not limited to, beating, blending, stirring, high shear stirring, low shear stirring, whipping, folding in, sonicating, sifting, pureeing, and the like.

pH is a measure of the acidity or basicity of a solution. As used herein, the term “low pH” refers to an acidic pH below pH 6, such as in the range of about 1 to about 6. Certain exemplary embodiments of the beverages disclosed here (e.g., cola beverage products) have a pH in the range of about 2.0 to 5.0, or in the range of about 2.5 to 4.0, or in the range of about 2.8 to 3.3 or in the range of about 3.0 to 3.2. As used herein, the term “high pH” refers to a basic pH in the range of about 8 to about 14. As used herein, the term “neutral pH” refers to a pH of about 7 (e.g., from about 6.0 to 8.0, or in the range of about 6.5 to about 7.5). Certain exemplary embodiments of the beverages disclosed here have a high pH, e.g., a pH in the range of about pH 8 to 14. Certain exemplary embodiments of the beverage products disclosed here have a neutral pH, e.g., a pH in the range of about pH 6 to pH 8, or in the range of about pH 6.5 to 7.5.

An acidulant comprising at least one edible acid is used in certain embodiments of the beverage products disclosed herein, including for instance cola beverages, and may serve any one or more of several functions, including, for example, lending tartness to the taste of the beverage, enhancing palatability, increasing thirst quenching effect, modifying sweetness and acting as a mild preservative. Suitable acids are known and will be apparent to those skilled in the art given the benefit of this disclosure. Exemplary acids suitable for use in some or all embodiments of the beverage products disclosed here include phosphoric acid, citric acid, malic acid, tartaric acid, lactic acid, fumaric acid, ascorbic acid, gluconic acid, succinic acid, maleic acid, adipic acid, cinnamic acid, glutaric acid, and mixtures of any of them. Typically, the acid is phosphoric acid, citric acid, malic acid, or combinations of any of them, such as, e.g., phosphoric acid and citric acid. In embodiments comprising natural beverage products (e.g., natural cola beverage products), the acid can be selected, e.g., from the group consisting of citric acid, malic acid, tartaric acid, formic acid, gluconic acid, lactic acid, fumaric acid, adipic acid, succinic acid, maleic acid, cinnamic acid, glutaric acid, and mixtures of any of them. For instance, in certain embodiments the acid comprises or consists essentially of lactic acid, tartaric acid and citric acid, and in certain embodiments the acid comprises or consists essentially of lactic acid and at least one of tartaric and citric acids.

Titratable acidity is an indication of the total acidity of a beverage product. Titratable acidity measures the amount of alkali required to neutralize the acid of a given volume of beverage. The titratable acidity is the milliliter of 0.1 N NaOH required to titrate 100 ml of beverage to a pH 8.75 end point with a potentiometer. The titratable acidity of certain embodiments of the beverage products disclosed here (e.g., cola beverage products) and at least one acid is typically about 8.75 to about 12.5, or from about 9 to about 11. Suitable titratable acidities include, e.g., about 9, 9.25, 9.5, 9.75, 10, 10.25, or 10.9.

The acid may be used in solution form, for example, and in an amount sufficient to provide the desired pH of the beverage. The particular acid or acids chosen and the amount used will depend, in part, on the other ingredients, the desired shelf life of the beverage product, as well as effects on the beverage pH, titratable acidity, and taste. Typically, for example, the one or more acids of the acidulant are used in an amount, collectively, of from about 0.01% to about 1.0% by weight of the beverage, e.g., from about 0.01% to about 0.5% by weight, from about 0.05% to about 0.5% by weight, from about 0.05% to about 0.25% by weight, from about 0.1% to about 0.25% by weight, depending upon the acidulant used, desired pH, other ingredients used, etc., of the beverage product (e.g., a cola beverage product). The pH of at least certain exemplary embodiments of the beverages disclosed here may be a value within the range of from about 2.0 to 5.0, about 2.5 to 4.0, about 2.8 to 3.3 or about 3.0 to 3.2, e.g., 3.1. The acid in certain exemplary embodiments enhances beverage flavor. Too much acid may impair the beverage flavor and result in tartness or other off-taste, while too little acid may make the beverage taste flat.

Those skilled in the art, given the benefit of this disclosure, will recognize that when preparing beverage products (e.g., cola beverage products) containing sweeteners in addition to rebaudioside M, such as peptide-based artificial sweeteners, such as aspartame, the resulting beverage composition is best maintained at a suitable pH. Specifically, the pH/stability curve for aspartame is a bell curve with pH 4.2 generally providing the best stability or shelf life. More specifically, such pH values are generally found to best retain the sweetening effect of the artificial sweetener. In the formation of calcium-supplemented beverages, the presence of calcium salt(s) may require additional acids to both assist the dissolution of the salt and maintain a desirable pH for stability of the artificial sweetener. The presence of the additional acid in the beverage composition, which increases the titratable acidity of the composition, will result in a more tart or sour taste to the resulting beverage. It will be within the ability of those skilled in the art, given the benefit of this disclosure, to select a suitable acid or combination of acids and the amounts of such acids for the acidulant component of any particular embodiment of the beverage products disclosed here.

Certain exemplary embodiments of the beverage products disclosed here, including for example cola beverage products, also may contain small amounts of alkaline agents, e.g., to adjust pH or for other purposes. Such agents include, e.g., potassium citrate and sodium citrate. For example, the alkaline agent potassium hydroxide may be used in an amount of from about 0.005 wt. % to about 0.02 wt. % (by weight of the beverage), with an amount of about 0.01% being typical for certain beverages. The amount will depend, of course, on the type of alkaline agents and on the degree to which the pH is to be adjusted.

The beverage products disclosed here optionally contain a flavor composition, for example, natural and synthetic fruit flavors, botanical flavors, other flavors, and mixtures thereof. As used here, the term “fruit flavor” refers generally to those flavors derived from the edible reproductive part of a seed plant. Included are both those wherein a sweet pulp is associated with the seed, e.g., banana, tomato, cranberry and the like, and those having a small, fleshy berry. The term berry also is used here to include aggregate fruits, i.e., not “true” berries, but fruit commonly accepted as such. Also included within the term “fruit flavor” are synthetically prepared flavors made to simulate fruit flavors derived from natural sources. Examples of suitable fruit or berry sources include whole berries or portions thereof, berry juice, berry juice concentrates, berry purees and blends thereof, dried berry powders, dried berry juice powders, and the like.

Exemplary fruit flavors include the citrus flavors, e.g., orange, lemon, lime grapefruit, tangerine, mandarin orange, tangelo, and pomelo, and such flavors as apple, grape, cherry, and pineapple flavors and the like, and mixtures thereof. In certain exemplary embodiments the beverage concentrates and other beverage products comprise a fruit flavor component, e.g., a juice concentrate or juice. As used here, the term “botanical flavor” refers to flavors derived from parts of a plant other than the fruit. As such, botanical flavors may include those flavors derived from essential oils and extracts of nuts, bark, roots and leaves. Also included within the term “botanical flavor” are synthetically prepared flavors made to simulate botanical flavors derived from natural sources. Examples of such flavors include cola flavors, tea flavors, and the like, and mixtures thereof. The flavor component may further comprise a blend of several of the above-mentioned flavors. In certain exemplary embodiments of the beverage concentrates and beverages a cola flavor component is used or a tea flavor component. The particular amount of the flavor component useful for imparting flavor characteristics to the beverage products of the present invention will depend upon the flavor(s) selected, the flavor impression desired, and the form of the flavor component. Those skilled in the art, given the benefit of this disclosure, will be readily able to determine the amount of any particular flavor component(s) used to achieve the desired flavor impression.

Juices suitable for use in at least certain exemplary embodiments of the beverage products disclosed here, including for example cola beverage products, include, e.g., fruit, vegetable and berry juices. Juices may be employed in the present invention in the form of a concentrate, puree, single-strength juice, or other suitable forms. The term “juice” as used here includes single-strength fruit, berry, or vegetable juice, as well as concentrates, purees, milks, and other forms. Multiple different fruit, vegetable and/or berry juices may be combined, optionally along with other flavorings, to generate a beverage having the desired flavor. Examples of suitable juice sources include plum, prune, date, currant, fig, grape, raisin, cranberry, pineapple, peach, banana, apple, pear, guava, apricot, Saskatoon berry, blueberry, plains berry, prairie berry, mulberry, elderberry, Barbados cherry (acerola cherry), choke cherry, date, coconut, olive, raspberry, strawberry, huckleberry, loganberry, currant, dewberry, boysenberry, kiwi, cherry, blackberry, quince, buckthorn, passion fruit, sloe, rowan, gooseberry, cashew apple, pomegranate, persimmon, mango, rhubarb, papaya, litchi, lemon, orange, lime, tangerine, mandarin and grapefruit etc. Numerous additional and alternative juices suitable for use in at least certain exemplary embodiments will be apparent to those skilled in the art given the benefit of this disclosure. In the beverages of the present invention employing juice, juice may be used, for example, at a level of at least about 0.2% by weight of the beverage. In certain exemplary embodiments juice is employed at a level of from about 0.2% to about 40% by weight of the beverage. Typically, juice may be used, if at all, in an amount of from about 1% to about 20% by weight.

Certain such juices which are lighter in color may be included in the formulation of certain exemplary embodiments to adjust the flavor and/or increase the juice content of the beverage without darkening the beverage color. Examples of such juices include apple, pear, pineapple, peach, lemon, lime, orange, apricot, grapefruit, tangerine, rhubarb, cassis, quince, passion fruit, papaya, mango, guava, litchi, kiwi, mandarin, coconut, and banana. Deflavored and decolored juices may be employed if desired.

Other flavorings suitable for use in at least certain exemplary embodiments of the beverage products disclosed here include, e.g., spice flavorings, such as cassia, clove, cinnamon, pepper, ginger, vanilla spice flavorings, cardamom, coriander, root beer, sassafras, ginseng, and others. Numerous additional and alternative flavorings suitable for use in at least certain exemplary embodiments will be apparent to those skilled in the art given the benefit of this disclosure. Flavorings may be in the form of an extract, oleoresin, juice concentrate, bottler's base, or other forms known in the art. In at least certain exemplary embodiments, such spice or other flavors complement that of a juice or juice combination.

The one or more flavorings may be used in the form of an emulsion. A flavoring emulsion may be prepared by mixing some or all of the flavorings together, optionally together with other ingredients of the beverage, and an emulsifying agent. The emulsifying agent may be added with or after the flavorings mixed together. In certain exemplary embodiments the emulsifying agent is water-soluble. Exemplary suitable emulsifying agents include gum acacia, modified starch, carboxymethylcellulose, gum tragacanth, gum ghatti and other suitable gums. Additional suitable emulsifying agents will be apparent to those skilled in the art of beverage formulations, given the benefit of this disclosure. The emulsifier in exemplary embodiments comprises greater than about 3% of the mixture of flavorings and emulsifier. In certain exemplary embodiments the emulsifier is from about 5% to about 30% of the mixture.

Carbon dioxide is used to provide effervescence to certain exemplary embodiments of the beverages disclosed here, including for example cola beverages. Any of the techniques and carbonating equipment known in the art for carbonating beverages may be employed. Carbon dioxide may enhance the beverage taste and appearance and may aid in safeguarding the beverage purity by inhibiting and destroying objectionable bacteria. In certain embodiments, for example, the beverage has a CO₂ level up to about 4.0 volumes carbon dioxide. Typical embodiments may have, for example, from about 0.5 to 5.0 volumes of carbon dioxide. As used here and independent claims, one volume of carbon dioxide is defined as the amount of carbon dioxide absorbed by any given quantity of liquid, e.g., water at 60° F. (16° C.) and one atmospheric pressure. A volume of gas occupies the same space as does the liquid by which it is dissolved. The carbon dioxide content may be selected by those skilled in the art based on the desired level of effervescence and the impact of the carbon dioxide on the taste or mouthfeel of the beverage. The carbonation may be natural or synthetic.

Optionally, caffeine may be added to various embodiments of the beverage products disclosed here, including for example cola beverage products. The amount of caffeine added is determined by the desired beverage properties, any applicable regulatory provisions of the country where the beverage is to be marketed, etc. In certain exemplary embodiments caffeine is included at a level of 0.02 percent or less by weight of the beverage. The caffeine must be of purity acceptable for use in foods and beverages. The caffeine may be natural or synthetic in origin.

The beverage concentrates and other beverage products, including for example cola beverage products, disclosed here may contain additional ingredients compatible with rebaudioside M, including, generally, any of those typically found in comestible formulations. These additional ingredients, for example, may typically be added to a stabilized beverage concentrate. Examples of such additional ingredients include, but are not limited to, caffeine, caramel and other coloring agents or dyes, antifoaming agents, gums, emulsifiers, tea solids, cloud components, and mineral and non-mineral nutritional supplements. Examples of non-mineral nutritional supplement ingredients are known to those of ordinary skill in the art and include, for example, antioxidants and vitamins, including Vitamins A, D, E (tocopherol), C (ascorbic acid), B (thiamine), B₂ (riboflavin), B₆, B₁₂, and K, niacin, folic acid, biotin, and combinations of any of them. The optional non-mineral nutritional supplements are typically present in amounts generally accepted under good manufacturing practices. Exemplary amounts are between about 1% and about 100% RDV (recommended daily value), where such RDV are established. In certain exemplary embodiments the non-mineral nutritional supplement ingredient(s) are present in an amount of from about 5% to about 20% RDV, where established.

Preservatives may be used in at least certain embodiments of the beverage products disclosed here, including for example cola beverage products. That is, at least certain exemplary embodiments contain an optional preservative system. For example, solutions with a pH below 4 and especially those below 3 typically are “microstable,” i.e., they resist growth of microorganisms, and so are suitable for longer term storage prior to consumption without the need for further preservatives. However, an additional preservative system may be used if desired. If a preservative system is used, it may be added to the beverage product at any suitable time during production, e.g., in some cases prior to the addition of rebaudioside M. As used here, the terms “preservation system” or “preservatives” include all suitable preservatives approved for use in food and beverage compositions, including, without limitation, such known chemical preservatives as benzoates, e.g., sodium, calcium, and potassium benzoate, sorbates, e.g., sodium, calcium, and potassium sorbate, citrates, e.g., sodium citrate and potassium citrate, polyphosphates, e.g., sodium hexametaphosphate (SHMP), and mixtures thereof, and antioxidants such as ascorbic acid, EDTA, BHA, BHT, TBHQ, dehydroacetic acid, dimethyldicarbonate, ethoxyquin, heptylparaben, and combinations of any of them. Preservatives may be used in amounts not exceeding mandated maximum levels under applicable laws and regulations. The level of preservative used typically is adjusted according to the planned final product pH, as well as an evaluation of the microbiological spoilage potential of the particular beverage formulation. The maximum level employed typically is about 0.05% by weight of the beverage. It will be within the ability of those skilled in the art, given the benefit of this disclosure, to select a suitable preservative or combination of preservatives for beverages according to this disclosure.

Other methods of food or beverage preservation suitable for at least certain exemplary embodiments of the beverage products disclosed here (e.g., cola beverage products) include, e.g., aseptic packaging and/or heat treatment or thermal processing steps, such as hot filling and tunnel pasteurization. Such steps can be used to reduce yeast, mold and microbial growth in the beverage products. For example, U.S. Pat. No. 4,830,862 to Braun et al. discloses the use of pasteurization in the production of fruit juice beverages as well as the use of suitable preservatives in carbonated beverages. U.S. Pat. No. 4,925,686 to Kastin discloses a heat-pasteurized freezable fruit juice composition which contains sodium benzoate and potassium sorbate. In general, heat treatment includes hot fill methods typically using high temperatures for a short time, e.g., about 190° F. for 10 seconds, tunnel pasteurization methods typically using lower temperatures for a longer time, e.g., about 160° F. for 10-15 minutes, and retort methods typically using, e.g., about 250° F. for 3-5 minutes at elevated pressure, i.e., at pressure above 1 atmosphere.

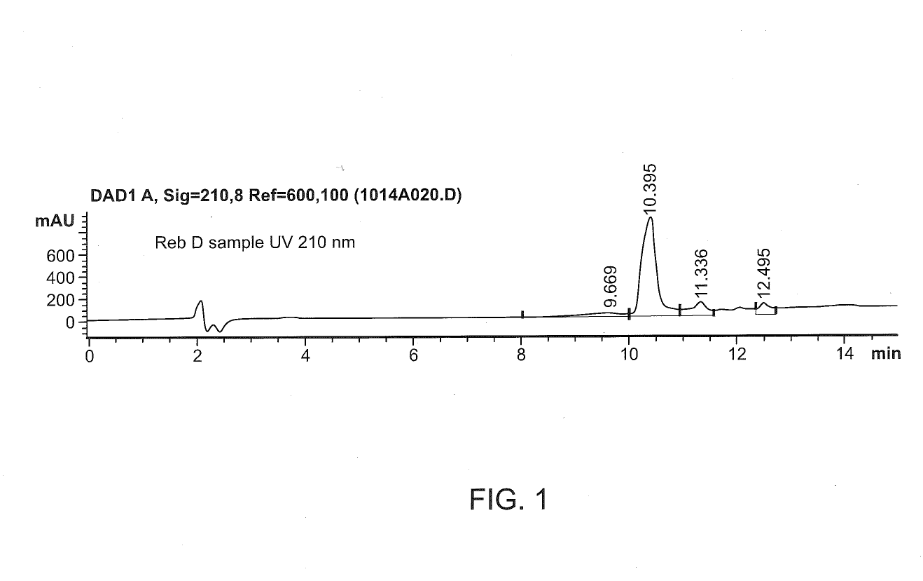

Referring to the drawings, FIG. 1 is a high pressure liquid chromatography (HPLC) chromatogram [with a diode array detector (DAD1) at UV 210 nm] showing trace presence of rebaudioside A and rebaudioside M (11.336 min retention time) in a commercial rebaudioside D sample. The trace amounts of rebaudioside A and rebaudioside M would not be sufficient to produce a sweetening effect in a beverage sweetened with the commercial rebaudioside D sample.

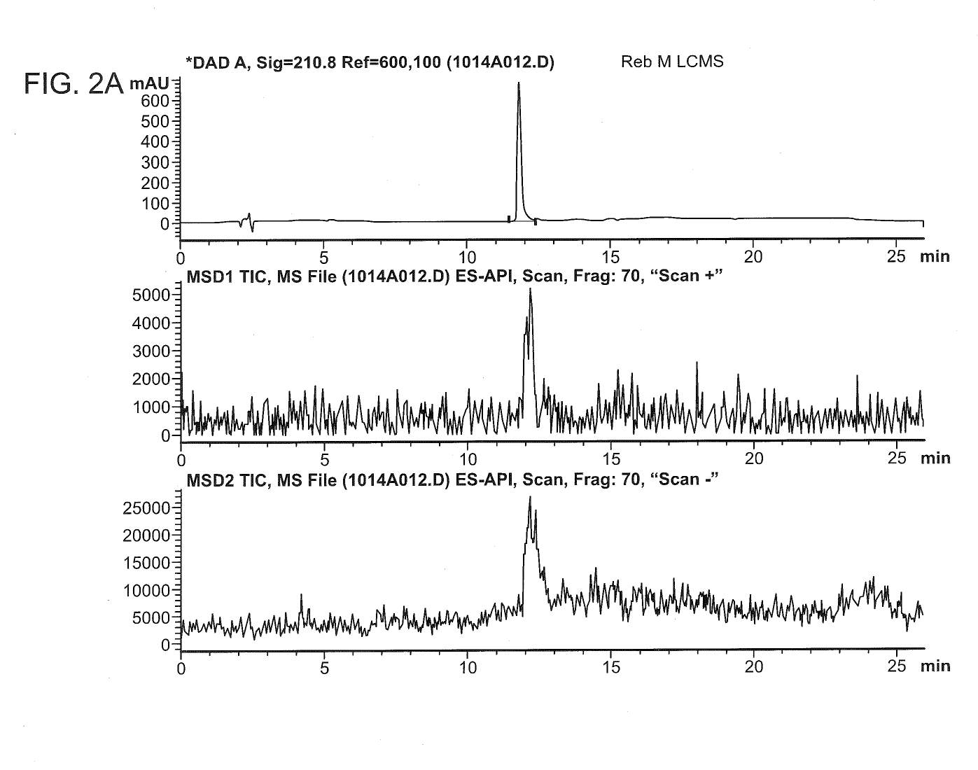

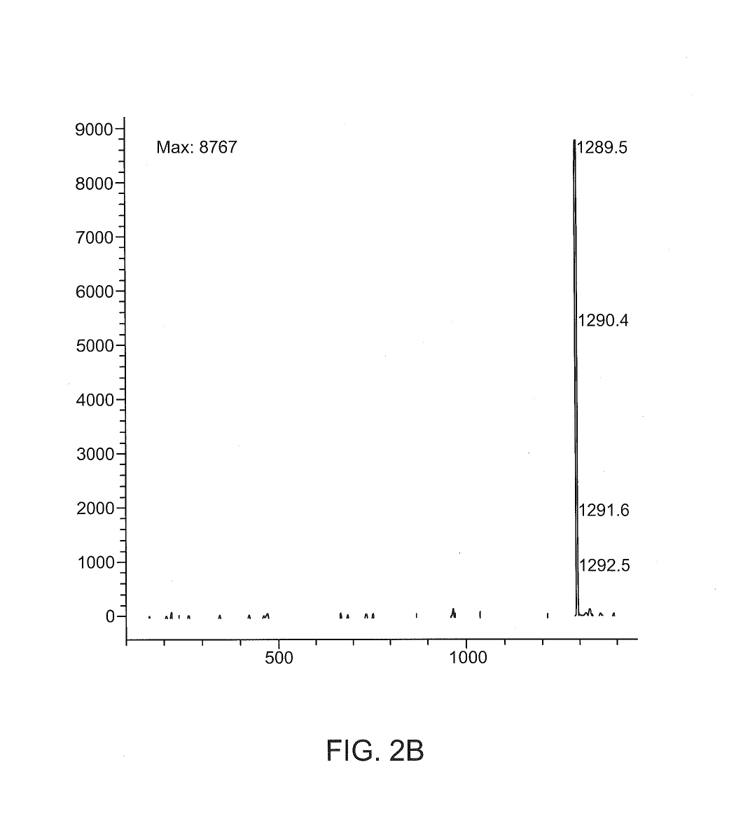

In FIG. 2, graphs show the results of liquid chromatography-mass spectroscopy (LC-MS) isolation of rebaudioside M. The conditions of the LC-MS runs that produced the results shown in the graphs of FIG. 1 and FIG. 2 are shown in Table 1, below:

TABLE 1
The conditions used for the HPLC chromatogram
of FIG. 1 are as follows:

Solvent A: Water with 0.1% formic acid
Solvent B: Methanol with 0.1% formic acid
pH: 3.1
Flow rate: 0.180 ml/min
UV detection at 210 nm
Mass spectrum: scan from 150-1600 amu
Electrospray ionization (ESI) acquired negative and positive ion spectra
Column: Phenomenex Kinetex 2.6μ C18 100 Å pore size 150 × 2.6 mm
with C18 guard cartridge.

### Gradient Table:

| Time (min) | Solvent A % | Solvent B % |
|---|---|---|
| 0 | 50 | 50 |
| 8 | 95 | 5 |
| 25 | 95 | 5 |
| 26 | 50 | 50 (equilibration, |
| | | acquisition of data stopped) |

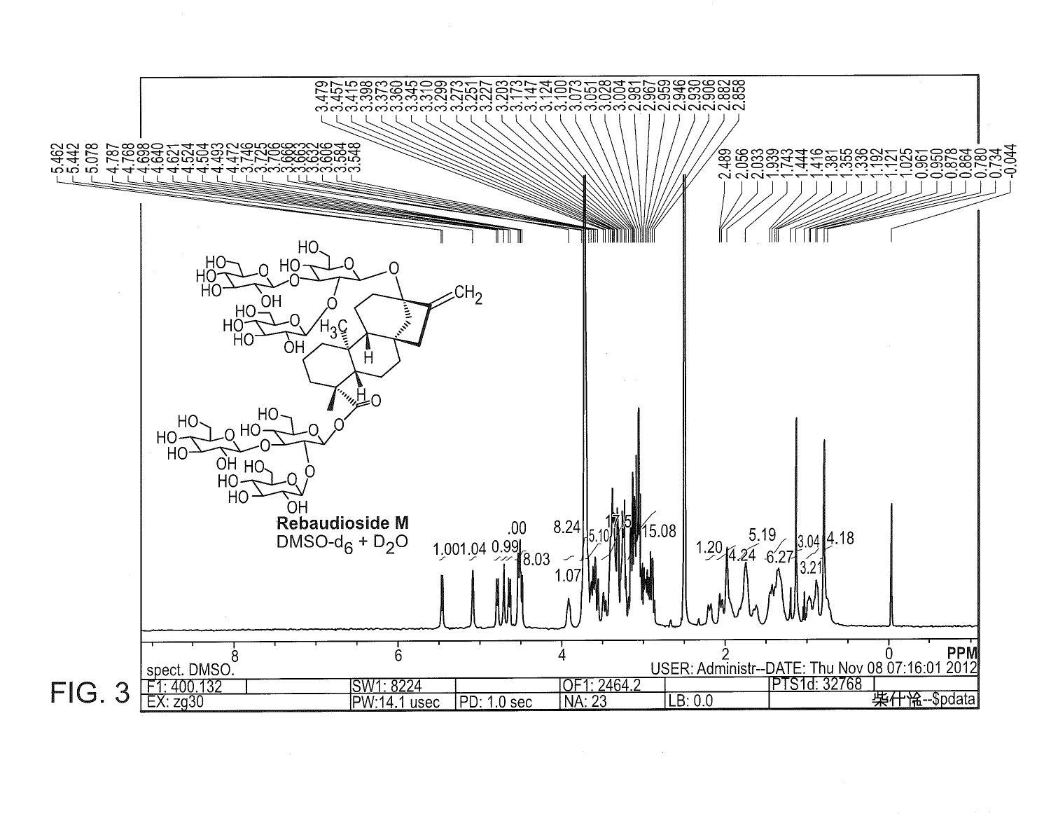

FIG. 3 is a graph showing the NMR spectrum for rebaudioside M, obtained using DMSO-d6 and D₂O.

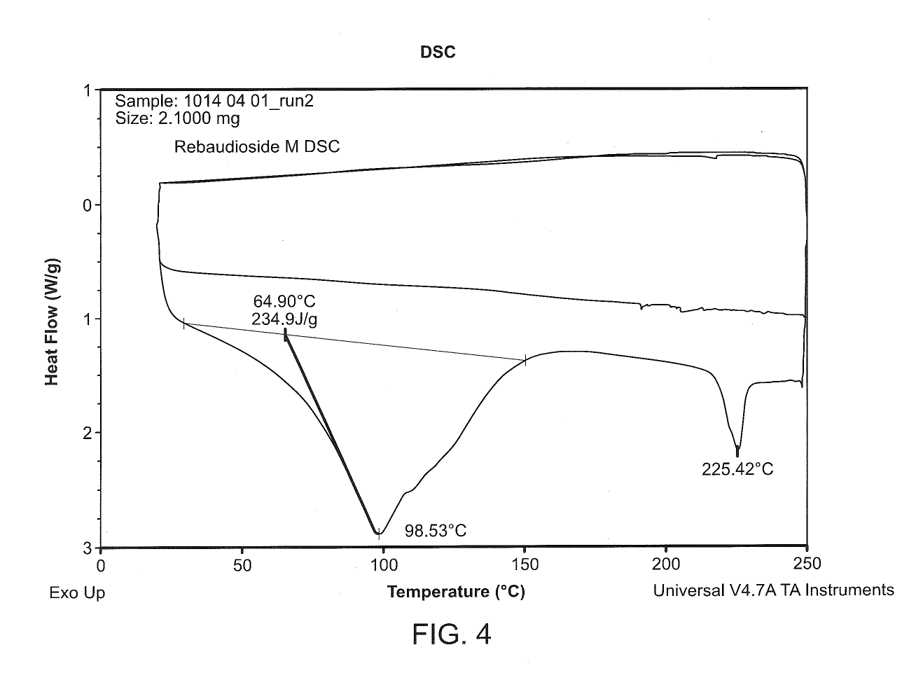

FIG. 4 is a differential scanning calorimetry graph for rebaudioside M. The second run showing little change indicates good thermo-stability of rebaudioside M.

### EXAMPLES

### Example 1

Sensory studies with two sets of acidified water samples were performed and are described below, where Set 1: HFCS-55 11.7%; Aspartame 400 ppm, and rebaudioside M 400 ppm; and Set 2: Aspartame 400 ppm, Rebaudioside M 400 ppm and Rebaudioside D 400 ppm. The sensory studies were conducted by 14 expertly trained panelists with two evaluations performed for each set. Table 2 and Table 3 show the sweetness scores for obtained by the sensory tests. The scale for scoring was 0 to 15, with 15 being the sweetest. The letters shown in Table 2 and Table 3, along with the numerical sweetness values will be understood by those skilled in the art to designate whether or not a statistically significant difference in taste was found. Thus, it can be seen in Table 1 that for Set 1 a statistically significant difference was found between the three sweeteners. It can be seen in Table 2 that for Set 2 a statistically significant difference in sweetness was found for rebaudioside M versus the other two sweeteners. More generally, it can be seen that for both Set 1 and Set 2, rebaudioside M had noticeably higher sweetness values. Thus, the results in Table 2 and Table 3 clearly indicate that rebaudioside M is significantly sweeter than aspartame and rebaudioside D.

TABLE 2

| | Rebaudioside D | Aspartame | Rebaudioside M | P-Value |
|---|---|---|---|---|
| Sweetness | b | c | a | 0.005 |
| | 6.97 | 6.39 | 7.58 | |

TABLE 3

| | HFCS-55 | Aspartame | Rebaudioside M | P-Value |
|---|---|---|---|---|
| Sweetness | b | B | a | 0.000 |
| | 6.10 | 6.30 | 8.00 | |

The following examples illustrate the advantageous taste of specific embodiments of the present invention and certain methods of preparation novel at least for their use of rebaudioside M sweetener or the use of rebaudioside sweetener in combination with other ingredients as listed below. The examples are not intended to limit the invention to the particular formulations or methods of preparation.

### Example 2

### Part A

Samples of finished ready-to-drink cola beverage were prepared for each of three different formulations. The formulations were identical except that syrup variant 1 used rebaudioside A as the sweetener, syrup variant 2 used rebaudioside D as the sweetener, and syrup variant 3 used rebaudioside M as the sweetener in accordance with one aspect of the invention of the present disclosure. For the ready-to-drink cola beverage samples of formulation variant 1 and formulation variant 3, 2.0 liters of syrup were prepared suitable for use in a 1-plus-5 throw with carbonated water to make the corresponding ready-to-drink cola beverage samples. To prepare variant 1 (comprising rebaudioside A as the sweetener) and variant 3 (comprising rebaudioside M as the sweetener), the ingredients listed in Table 4, below, were added (in the sequence listed) to approximately 1.0-1.5 liter purified water with stirring. Purified water was then added until the syrup was 2 liters in volume. Then 50 mL portions of the syrup were added respectively to 250 mL portions of carbonated water, i.e., a “1-plus-5 throw” to obtain samples of finished ready-to-drink cola beverage corresponding to each of the two syrup variants. Due to poor solubility of rebaudioside D, syrup cola beverage samples sweetened by rebaudioside D were prepared differently. Specifically, the unsweetened cola beverage samples were made first in sample bottles. Then, to each bottle 400 ppm of Reb D was carefully added in. The bottles were sealed and shaken to ensure solubilization of Reb D.

TABLE 4

| Ingredients | Variant 1 | Variant 2 | Variant 3 |
|---|---|---|---|
| Sodium benzoate | 2.04 g | 2.04 g | 2.04 g |
| Phosphoric acid | 4.41 g | 4.41 g | 4.41 g |
| Caffeine | 1.27 g | 1.27 g | 1.27 g |
| Citric acid | 1.63 g | 1.63 g | 1.63 g |
| Cola flavors | 38.63 g | 38.63 g | 38.63 g |
| Sweetener | Reb A 4.8 g | Reb D 4.8 g | Reb M 4.8 g |

### Example 2

### Part B

Samples of the three different variants of ready-to-drink cola beverages sweetened, respectively, with 400 ppm of rebaudioside A, 400 ppm of rebaudioside D, and 400 ppm of rebaudioside M, were prepared as described above and placed in storage. After being in storage for days, the samples were subjected to sensory testing, being evaluated by five people familiar with taste testing cola beverages, including diet cola beverage taste testing. The samples of variant 3 (ready-to-drink cola beverage samples sweetened with 400 ppm rebaudioside M) were judged as the best tasting of the samples. The samples of variant 1, i.e., the ready-to-drink cola beverage samples sweetened with 400 ppm of rebaudioside A, were found to have significant detectable bitter aftertaste and judged as the least favored.

### Example 3

### Part A

The taste quality of rebaudioside M-sweetened formulations of diet cola beverages in accordance with one aspect of the invention of the present disclosure was improved by the addition of low calorie, low potency sweeteners, such as erythritol (0 to 3.5 wt. %), D-tagatose (0 to 1 wt. %), D-psicose (FDA GRAS#400; 0 to 2.1 wt. %) or a combination of any of them. Samples of finished ready-to-drink cola beverage were prepared for each of six different such formulations. The formulations were ready-to-drink diet cola beverages sweetened by 500 ppm of rebaudioside M and were identical except for the low calorie, low potency sweetener ingredient bulking agents shown in Table 5, below. As seen in Table 5, each of the six variants contained erythritol, D-tagatose and/or D-psicose. The samples of each of the six variants were evaluated by five people familiar with cola beverages and cola beverage taste testing. Specifically, the samples of the six formulation variants were tasted and compared to each other and to control samples that were the same except for having no low calorie, low potency sweetener ingredient bulking agent.

TABLE 5

| Control | V-1 | V-2 | V-3 | V-4 | V-5 | V-6 |
|---|---|---|---|---|---|---|
| No | +1% | | | +1% | +0.5% | +1% |
| erythritol | erythritol | | | Erythritol | erythritol | erythritol |
| No D-tagatose | | +0.75% | | +0.25% | | |
| | | D-tagatose | | D-tagatose | | |
| No D-psicose | | | +1% | | +0.5% | +1% |
| | | | D-psicose | | D-psicose | D-psicose |

### Example 3

### Part B

The results of taste testing the samples of the six variants by five people familiar with taste testing cola beverages, including diet cola beverage taste testing. The taste testing showed that adding a bulking agent enhanced the mouthfeel of the samples relative to the control samples. Further, the variants with D-psicose were unexpectedly found to have also improved up-front sweetness. Up-front sweetness is generally lacking in beverages sweetened by steviol glycosides, and this additional advantageous effect in variant 3, variant 5 and variant 6 was an unexpected phenomenon. Variant 5 and variant 6 were judged as the best among all variants. Variant 6 was perceived as having taste close to the taste of current commercial diet colas sweetened with aspartame or other artificial sweetener, but with significantly better mouthfeel.

### Example 4

### Part A

Samples of finished ready-to-drink diet cola beverage in accordance with one aspect of the invention of the present disclosure were prepared for each of two formulation variants. The formulations were ready-to-drink diet cola beverages sweetened by rebaudioside M. Variant 1 had no low potency sweetener ingredients while Variant 2 did have low potency sweetener ingredients, as shown in Table 6, below. Samples of both variants were evaluated by two people familiar with cola beverages and cola beverage taste testing.

TABLE 6

| Ingredients | Diet Cola Variant 1 | Diet Cola Variant 2 |
|---|---|---|
| Sodium benzoate | 2.04 g | 2.04 g |
| Phosphoric acid | 4.41 g | 4.41 g |
| Caffeine | 1.27 g | 1.27 g |
| Citric acid | 1.27 g | 1.27 g |
| Rebaudioside M | 3.6 g | 3.3 g |
| D-psicose | 0 | 30 g |
| Erythritol | 0 | 30 g |
| Treated water | q.s. to 1 L | q.s. to 1 L |

### Example 4

### Part B

Two people familiar with taste testing cola beverages, including diet cola beverage taste testing, tasted the samples of Variant 1 and Variant 2. Each was found to have a good sweetness taste profile and mouthfeel, while Variant 2 had a better sweetness taste profile and mouthfeel than Variant 1.

### Example 5

### Part A

Samples of finished ready-to-drink diet cola beverages sweetened by rebaudioside M in accordance with one aspect of the invention of the present disclosure were prepared for two formulation variants. Each of the two variants was sweetened with 1.5 g of rebaudioside M together with 2.0 g of soluble Reb D (i.e., rebaudioside D together with rebaudioside A in 7:3 weight ratio). Variant 1 had no low potency sweetener ingredients while Variant 2 did have low potency sweetener ingredients, as shown in Table 7, below. Samples of both variants were evaluated by two people familiar with taste testing cola beverages, including diet cola beverage taste testing.

TABLE 7

| | Variant 1 | Variant 2 |
|---|---|---|
| | Diet Cola Beverage without | Diet Cola Beverage with |
| Ingredients | D-Psicose and Erythritol | D-Psicose and Erythritol |
| Sodium benzoate | 2.04 g | 2.04 g |
| Phosphoric acid | 4.41 g | 4.41 g |
| Caffeine | 1.27 g | 1.27 g |
| Citric acid | 1.27 g | 1.27 g |
| Cola flavor | 38.63 g | 38.63 g |
| Rebaudioside A* | 0.45 g | 0.45 g |
| Rebaudioside D* | 1.05 g | 1.05 g |
| Rebaudioside M | 1.5 g | 1.5 g |
| D-Psicose | 0 | 120 g |
| Erythritol | 0 | 120 g |
| Treated water | q.s. to 1 L | q.s. to 1 L |

### Example 5

### Part B

Two people familiar with taste testing cola beverages, including diet cola beverage taste testing, tasted the samples of Variant 1 and Variant 2. Each was found to have a good sweetness taste profile and mouthfeel, while Variant 2 had a significantly better sweetness quality and mouthfeel than Variant 1.

### Example 6

### Part A

Samples of finished ready-to-drink diet cola beverage in accordance with one aspect of the invention of the present disclosure were prepared for each of two formulation variants. The formulations were ready-to-drink diet cola beverages sweetened by rebaudioside M. Variant 1 had no low potency sweetener ingredients while Variant 2 did have low potency sweetener ingredients, as shown in Table 8, below. Samples of both variants were evaluated by two people familiar with taste testing cola beverages, including diet cola beverage taste testing.

TABLE 8

| Ingredients | Diet Cola Variant 1 | Diet Cola Variant 2 |
|---|---|---|
| Sodium benzoate | 2.04 g | 2.04 g |
| Phosphoric acid | 4.41 g | 4.41 g |
| Caffeine | 1.27 g | 1.27 g |
| Citric acid | 1.27 g | 1.27 g |
| Rebaudioside M | 2.4 g | 2.4 g |
| D-psicose | 0 | 120 g |
| Erythritol | 0 | 120 g |
| Treated water | q.s. to 1 L | q.s. to 1 L |

### Example 6

### Part B

Six people familiar with taste testing cola beverages, including diet cola beverage taste testing, tasted the samples of Variant 1 and Variant 2. Each was found to have a good sweetness taste profile and mouthfeel, while Variant 2 had a better sweetness taste profile and mouthfeel than Variant 1.

### Example 7

Ready-to-drink low calorie, frozen beverage sweetened by rebaudioside M in accordance with one aspect of the invention of the present disclosure are prepared from a concentrate syrup. The formulation includes low potency sweetener, as shown in Table 9, below. The concentrate syrup of Table 9 is diluted with water in a 1-plus-5 throw to produce a beverage mixture. The beverage mixture is poured into a hopper of a frozen beverage unit to generate frozen beverage which is dispensed and further flavored by adding flavored syrup.

TABLE 9

| Ingredients | Amount |
|---|---|
| Sodium benzoate | 2.88 g |
| Citric acid anhydrous | 3.98 g |
| Rebaudioside M | 0.5 g |
| D-Psicose | 120 g |
| Erythritol | 120 g |
| HFCS | 570 g |
| Treated water | q.s. to 2 L |

### Example 8

A sweetener composition suitable for use in bulk in food preparation or as a table-top sweetener, comprising rebaudioside M in accordance with one aspect of the invention of the present disclosure, is prepared with the formulation shown in Table 10, below. The sweetener composition of Table 10 is suitable for use as an ingredient in cooking or for addition to water or other liquids or to other food for immediate consumption. The sweetener composition can be packaged in bulk or in packets each containing a suggested single serving size. Optionally a trace amount of flavoring (e.g., not more than 0.01 g) or a larger concentration of flavoring can be added to the formulation shown in Table 10.

TABLE 10

| Ingredient | Amount |
|---|---|
| Erythritol | 1.745 g |
| D-Psicose | 1.745 g |
| Rebaudioside M | 0.0175 g |
| Total weight | 3.5075 |

### Example 9

Diet frozen carbonated beverage is prepared in accordance with one aspect of the invention of the present disclosure. Beverage syrup for the frozen carbonated beverage is prepared by adding erythritol (3.5% by weight of finished beverage) and D-Psicose (2.1% by weight of finished drink) to 1.0 gallon of unsweetened lemon-lime CSD base (e.g., Diet Mountain Dew® base or other lemon-lime CSD base). The solution is stirred until complete dissolution has occurred. Rebaudioside M (500 ppm of finished beverage) is added, and again the solution is stirred until complete dissolution is achieved. The syrup thus prepared is placed into a frozen carbonated beverage machine (“FCB Dispenser”) configured to add carbonated water to the syrup at the time of dispensing ready-to-drink servings of the finished frozen carbonated beverage. The resulting ready-to-drink servings of the finished frozen carbonated beverage have good carbon dioxide overrun, smooth, creamy mouthfeel and excellent taste. The syrup is then successively run through the FCB Dispenser to consistently achieve high quality ready-to-drink servings of finished frozen carbonated beverage.

Given the benefit of the above disclosure and description of exemplary embodiments, it will be apparent to those skilled in the art that numerous alternative and different embodiments are possible in keeping with the general principles of the invention disclosed here. Those skilled in this art will recognize that all such various modifications and alternative embodiments are within the true scope and spirit of the invention. The appended claims are intended to cover all such modifications and alternative embodiments. It should be understood that the use of a singular indefinite or definite article (e.g., “a,” “an,” “the,” etc.) in this disclosure and in the following claims follows the traditional usage in patents of meaning “at least one” unless in a particular instance it is clear from context that the term is intended in that particular instance to mean specifically one and only one. Likewise, in accordance with traditional usage the term “comprising” is used here an open ended, i.e., not excluding additional items, features, components, etc., while the term “consisting of” is closed ended, excluding additional items, features, components, etc. Likewise, also in accordance with traditional usage, the term “consisting essentially of” limits to the recited material(s) or step(s) but also allows the optional inclusion of material(s) or step(s) that do not materially affect the basic and novel characteristic(s) of the claimed invention.

What is claimed is:

1. A food product comprising a sweetening amount of rebaudioside M and at least one other food ingredient.

2. The food product of claim 1 wherein the at least one other food ingredient comprising a sweetening amount of a potent sweetener other than rebaudioside M, a sweetening amount of a nutritional sweetener, a component of a cereal grain, or a combination of any two or more of them.

3. The food product of claim 1 wherein the food product is a noncarbonated beverage, a carbonated beverage, a frozen beverage, a fountain beverage, or a dairy beverage.

4. The food product of claim 1 wherein the food product is a sweetener composition comprising a sweetening amount of rebaudioside M and at least one other edible ingredient selected from a bulking agent, erythritol, D-psicose, D-tagatose and a combination of any two or more of them.

5. The food product of claim 1 wherein the food product is a beverage product, and wherein the at least one other food ingredient comprises water and flavoring.

6. The food product of claim 5 wherein the food product is a ready-to-drink diet carbonated beverage further comprising:
erythritol, D-psicose, D-tagatose, or combination of any two or more of them; and
rebaudioside A and rebaudioside D.

7. The food product of claim 5 wherein the food product is a frozen carbonated beverage.

8. The food product of claim 5 wherein the food product is a syrup suitable to be diluted by a 1-plus-5 throw with carbonated water to produce a ready-to-drink carbonated beverage.

9. A beverage product comprising water, flavoring and sweetener component comprising a sweetening amount of rebaudioside M.

10. The beverage product of claim 9 wherein the beverage product is a ready-to-drink beverage having a pH higher than 3.0 and lower than 4.0.

11. The beverage product of claim 9 wherein the beverage product is a syrup suitable to be diluted by a 1-plus-5 throw with carbonated water to produce a ready-to-drink carbonated beverage having a pH higher than 3.0 and lower than 4.0, wherein the rebaudioside M is present in a concentration from 300 to 3000 ppm.

12. The beverage product of claim 9 wherein the sweetener component consists essentially of rebaudioside M.

13. The beverage product of claim 9 wherein the sweetener component further comprises a sweetening amount of at least one other potent sweetener selected from artificial potent sweeteners and natural potent sweeteners.

14. The beverage product of claim 9 further comprising acidulant comprising at least one acid, wherein:
the beverage product is a carbonated diet cola beverage product having a pH higher than 3.0 and lower than 4.0;
the water comprises carbonated water;
the flavoring comprises cola flavor; and
the sweetener component comprises rebaudioside M in a concentration between 50 ppm and 600 ppm.

15. The beverage product of claim 14 wherein the sweetener component consists essentially of rebaudioside M.

16. The beverage product of claim 14 wherein the sweetener component further comprises a sweetening amount of at least one additional sweetener and the rebaudioside M provides at least ten percent (10%) of the total sweetening of the beverage product, and wherein the additional sweetener is selected from the group consisting of rebaudioside A, rebaudioside B, rebaudioside C, rebaudioside D, sucrose, monatin, thaumatin, monellin, brazzein, L-alanine, glycine, Lo Han Guo, mogrocides, hernandulcin, phyllodulcin, trilobtain, and a combination of any two or more of them.

17. The beverage product of claim 14 wherein rebaudioside M is at least fifty weight percent (50.0 wt. %) of the sweetener component.

18. The beverage product of claim 14 wherein rebaudioside M is at least ninety weight percent (90%) of the sweetener component.

19. The beverage product of claim 14 wherein the sweetener component further comprises a sweetening amount of rebaudioside A and a sweetening amount of rebaudioside D.

20. The beverage product of claim 14 wherein the acidulant consists essentially of phosphoric acid, lactic acid, tartaric acid, citric acid or a combination of any two or more of them.

21. The beverage product of claim 14 wherein the rebaudioside M has a purity of at least 95.0 weight percent (95.0 wt. %).

22. The beverage product of claim 9 further comprising at least one additional ingredient selected from the group consisting of fruit juice, vegetable juice, pulp, colorants, vitamins, minerals, electrolytes, erythritol, D-tagatose, D-psicose and glycerine.

23. A beverage syrup suitable to be diluted by a 1-plus-5 throw with carbonated water to produce a ready-to-drink, diet, carbonated cola beverage, wherein the syrup comprises:
acidulant comprising at least one acid, wherein the acidulant is present in an amount sufficient to yield a pH higher than 3.0 and lower than 4.0 in the ready-to-drink, diet, carbonated cola beverage;
sweetener component comprising rebaudioside M in concentration sufficient to provide a sweetening amount of rebaudioside M in the ready-to-drink, diet, carbonated cola beverage; and
flavoring component comprising cola flavoring, in concentration sufficient to provide cola flavor in the ready-to-drink, diet, carbonated cola beverage.

24. The beverage syrup of claim 23 further comprising erythritol and D-psicose in concentrations sufficient, collectively, to provide improved mouthfeel and up-front sweetness in the ready-to-drink, diet, carbonated cola beverage.

25. A sweetener composition comprising rebaudioside M and at least one other edible ingredient.

26. The sweetener composition of claim 25 wherein the at least one other edible ingredient is a flavorant, a flowing agent, a coloring agent, a bulking agent.

27. The sweetener composition of claim 26 wherein the sweetener composition is packaged in a single serving quantity.
